(19) United States
(12) Patent Application Publication
(10) Pub. No.: US 2024/0053511 A1
(43) Pub. Date: Feb. 15, 2024

(54) LIGHT ABSORPTION ANISOTROPIC FILM, MANUFACTURING METHOD OF LIGHT ABSORPTION ANISOTROPIC FILM, DISPLAY DEVICE, CAMERA, SENSOR, AND APPARATUS

(71) Applicant: FUJIFILM Corporation, Tokyo (JP)

(72) Inventors: Shinichi MORISHIMA, Kanagawa (JP); Yuki HIRAI, Kanagawa (JP); Ryoji HIMENO, Kanagawa (JP)

(73) Assignee: FUJIFILM Corporation, Tokyo (JP)

(21) Appl. No.: 18/481,046

(22) Filed: Oct. 4, 2023

Related U.S. Application Data
(63) Continuation of application No. PCT/JP2022/017390, filed on Apr. 8, 2022.

(30) Foreign Application Priority Data
Apr. 9, 2021 (JP) 2021-066766

(51) Int. Cl. G02B 1/08; G02B 5/30; G02B 5/20

(52) U.S. Cl. CPC G02B 1/08; G02B 5/3016; G02B 5/208

(57) ABSTRACT

A light absorption anisotropic film which has absorption in a range of a near-infrared region (particularly, a wavelength of 700 to 1600 nm) and is excellent in bendability, a manufacturing method of a light absorption anisotropic film, a display device, a camera, a sensor, and an apparatus. The light absorption anisotropic film contains a dichroic substance having a hydrophilic group, in which a film thickness is 10 m or less and the light absorption anisotropic film has a maximal absorption wavelength in a wavelength range of 700 to 1600 nm.

### CROSS-REFERENCE TO RELATED APPLICATIONS

This application is a Continuation of PCT International Application No. PCT/JP2022/017390 filed on Apr. 8, 2022, which claims priority under 35 U.S.C. § 119(a) to Japanese Patent Application No. 2021-066766 filed on Apr. 9, 2021. The above applications are hereby expressly incorporated by reference, in their entirety, into the present application.

### BACKGROUND OF THE INVENTION

### 1. Field of the Invention

The present invention relates to a light absorption anisotropic film, a manufacturing method of a light absorption anisotropic film, a display device, a camera, a sensor, and an apparatus.

### 2. Description of the Related Art

In recent years, there has been a demand for a light absorption anisotropic film having absorption in an infrared region in various applications such as a display device, a camera, and a sensor.

For example, WO2018/088558A discloses a polarizing plate having absorption in an infrared region, which is the light absorption anisotropic film. The above-described polarizing plate is obtained by infusing a polyvinyl alcohol film with a dichroic substance which absorbs infrared rays by an infusing treatment, and stretching the obtained film.

### SUMMARY OF THE INVENTION

On the other hand, in recent years, with the development of a flexible device, there has been a demand for a light absorption anisotropic film which has absorption in a near-infrared region having a wavelength of 700 to 1600 nm and is excellent in bendability.

As a result of examination on the bendability of the polarizing plate disclosed in WO2018/088558A, the present inventors have found that the current requirement level has not been satisfied and thus further improvement is necessary.

An object of the present invention is to provide a light absorption anisotropic film which as absorption in a range of a near-infrared region (particularly, a wavelength of 700 to 1600 nm) and is excellent in bendability.

Another object of the present invention is to provide a manufacturing method of a light absorption anisotropic film, a display device, a camera, a sensor, and an apparatus.

As a result of extensive studies on the problems of the related art, the present inventors have found that the foregoing objects can be achieved by the following configurations.
(1) Alight absorption anisotropic film comprising:
   a dichroic substance having a hydrophilic group,
   in which a film thickness is 10 μm or less, and
   the light absorption anisotropic film has a maximal absorption wavelength in a wavelength range of 700 to 1600 nm.
(2) The light absorption anisotropic film according to (1),
   in which the light absorption anisotropic film contains a J-aggregate composed of the dichroic substance.
(3) The light absorption anisotropic film according to (1) or (2),
   in which an alignment degree of the dichroic substance is 0.60 or more.
(4) The light absorption anisotropic film according to any one of (1) to (3),
   in which the light absorption anisotropic film contains two or more kinds of the dichroic substances, and
   the light absorption anisotropic film has a first maximal absorption wavelength in a wavelength range of 700 nm or more and less than 900 nm and a second maximal absorption wavelength in a wavelength range of 900 to 1600 nm.
(5) The light absorption anisotropic film according to any one of (1) to (4), further comprising:
   a non-colorable lyotropic liquid crystal compound.
(6) A manufacturing method of a light absorption anisotropic film, comprising:
   a step 1 of subjecting a composition containing a dichroic substance having a hydrophilic group and a solvent to a pulverization treatment; and
   a step 2 of applying the composition obtained in the step 1 and aligning the dichroic substance in the applied composition to form a light absorption anisotropic film.
(7) The manufacturing method of a light absorption anisotropic film according to (6),
   in which the composition obtained in the step 1 contains particles composed of the dichroic substance, and
   an average particle diameter of the particles is 10 to 1000 nm.
(8) The manufacturing method of a light absorption anisotropic film according to (6) or (7),
   in which the pulverization treatment is a treatment selected from the group consisting of a mechanical milling treatment and an ultrasonic treatment.
(9) The manufacturing method of a light absorption anisotropic film according to any one of (6) to (8),
   in which the composition contains a non-colorable lyotropic liquid crystal compound, and
   in the step 2, the composition is subjected to a shearing treatment to align the dichroic substance.
(10) The manufacturing method of a light absorption anisotropic film according to (9), further comprising, after the step 2:
   a step 3 of immobilizing the lyotropic liquid crystal compound.
(11) A display device comprising:
   the light absorption anisotropic film according to any one of (1) to (5).
(12) A camera comprising:
   the light absorption anisotropic film according to any one of (1) to (5).
(13) A sensor comprising:
   the light absorption anisotropic film according to any one of (1) to (5).
(14) An apparatus comprising:
   the light absorption anisotropic film according to any one of (1) to (5); and an infrared light source.

According to the present invention, it is possible to provide a light absorption anisotropic film which as absorption in a range of a near-infrared region (particularly, a wavelength of 700 to 1600 nm) and is excellent in bendability.

In addition, according to the present invention, it is possible to provide a manufacturing method of a light absorption anisotropic film, a display device, a camera, a sensor, and an apparatus.

### BRIEF DESCRIPTION OF THE DRAWINGS

FIG. 1 is a schematic view showing an example of an alignment direction of a dichroic substance in a light absorption anisotropic film.

### DESCRIPTION OF THE PREFERRED EMBODIMENTS

Hereinafter, the present invention will be described in detail.

Any numerical range expressed using “to” in the present specification refers to a range including the numerical values before and after the “to” as a lower limit value and an upper limit value, respectively.

In addition, in the present specification, a relationship between angles (for example, “orthogonal”, “parallel”, and the like) is intended to include a range of errors acceptable in the art to which the present invention belongs. For example, it means that an angle is in an error range of ±5° with respect to the exact angle, and the error with respect to the exact angle is preferably in a range of ±3°.

A bonding direction of a divalent group (for example, —COO—) described in the present specification is not particularly limited. For example, in a case where L in X-L-Y is —COO— and in a case where the position bonded to the X side is defined as *1 and the position bonded to the Y side is defined as *2, L may be *1-O—CO—*2 or *1-CO—O—*2.

In the following, first, materials contained in the light absorption anisotropic film will be described in detail, and then characteristics, manufacturing method, and use of the light absorption anisotropic film will be described in detail.

<Light Absorption Anisotropic Film>

The light absorption anisotropic film according to the embodiment of the present invention contains a dichroic substance having a hydrophilic group (hereinafter, also simply referred to as “specific dichroic substance”).

In the following, first, the above-described specific dichroic substance will be described in detail.

(Specific Dichroic Substance)

The dichroic substance means a substance having different absorbances depending on directions.

The specific dichroic substance may or may not exhibit liquid crystallinity (for example, lyotropic liquid crystallinity).

In a case where the specific dichroic substance exhibits the liquid crystallinity, any of nematic properties, smectic properties, or columnar properties may be exhibited.

The specific dichroic substance has a hydrophilic group.

Examples of the hydrophilic group include an acid group or a salt thereof, an onium base, a hydroxy group or a salt thereof, a sulfonamide group (H₂N—SO₂—), and a polyoxyalkylene group. Among these, an acid group or a salt thereof is preferable.

The onium base is a group derived from an onium salt, and examples thereof include an ammonium base (*—N⁺(R^{Z})₃A⁻), a phosphonium base (*—P⁺(R^{Z})₃A⁻), and a sulfonium base (*—S⁺(R^{Z})₂A⁻). R^{Z}'s each independently represent a hydrogen atom, an alkyl group, an aryl group, or a heteroaryl group. A⁻ represents an anion (for example, a halogen ion). * represents a bonding position.

The salt of the hydroxy group is represented by *—O-M+, and M⁺ represents a cation and * represents a bonding position. Examples of the cation represented by M⁺ include a cation in a salt of an acid group, which will be described below.

Examples of the polyoxyalkylene group include a group represented by R^{Z}—(O-L^{Z})ₙ-*. R^{Z} is as described above. L^{Z} represents an alkylene group. * represents a bonding position.

Examples of the acid group or a salt thereof include a sulfo group (—SO₃H) or a salt thereof (—SO₃M⁺; M⁺ represents a cation), and a carboxyl group (—COOH) or a salt thereof (—COO-M⁺; M⁺ represents a cation), and from the viewpoint that the alignment of the specific dichroic substance in the light absorption anisotropic film is more excellent, a sulfo group or a salt thereof is preferable.

The above-described salt refers to a salt in which the hydrogen ion of the acid is replaced with another cation such as a metal ion. That is, the salt of an acid group refers to a salt in which the hydrogen ion of the acid group such as a —SO₃H group is replaced with another cation.

Examples of the cation in the salt of an acid group (for example, a cation in the salt of a sulfo group and a cation in the salt of a carboxyl group) include Na⁺, K⁺, Li⁺, Rb⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, and Zr⁴⁺. Among these, from the viewpoint that the alignment of the specific dichroic substance in the light absorption anisotropic film is more excellent, an alkali metal ion is preferable, Na⁺, K⁺, or Li⁺ is more preferable, and Li⁺ is still more preferable.

The specific dichroic substance preferably has a maximal absorption wavelength in a wavelength range of 700 to 1600 nm. That is, the specific dichroic substance is preferably a near-infrared absorbing dichroic substance.

The type of the specific dichroic substance (particularly, the near-infrared absorbing dichroic substance having a hydrophilic group) is not particularly limited, and examples thereof include known materials. Examples of the specific dichroic substance include dichroic coloring agents having a hydrophilic group, and examples thereof include a phthalocyanine-based coloring agent having a hydrophilic group, a naphthalocyanine-based coloring agent having a hydrophilic group, a metal complex-based coloring agent having a hydrophilic group, a boron complex-based coloring agent having a hydrophilic group, a cyanine-based coloring agent having a hydrophilic group, an oxonol-based coloring agent having a hydrophilic group, a squarylium-based coloring agent having a hydrophilic group, a rylene-based coloring agent having a hydrophilic group, a diimonium-based coloring agent having a hydrophilic group, a diphenylamines-based coloring agent having a hydrophilic group, a triphenylamines-based coloring agent having a hydrophilic group, a quinone-based coloring agent having a hydrophilic group, and an azo-based coloring agent having a hydrophilic group. In general, these coloring agents extend an absorption wavelength to a long wavelength side by extending the existing n-conjugated system, and exhibit a wide variety of absorption wavelengths depending on their structure.

The definition of the hydrophilic group included in the coloring agents exemplified above (a phthalocyanine-based coloring agent having a hydrophilic group, a naphthalocyanine-based coloring agent having a hydrophilic group, a metal complex-based coloring agent having a hydrophilic group, a boron complex-based coloring agent having a hydrophilic group, a cyanine-based coloring agent having a hydrophilic group, an oxonol-based coloring agent having a hydrophilic group, a squarylium-based coloring agent having a hydrophilic group, a rylene-based coloring agent having a hydrophilic group, a diimonium-based coloring agent having a hydrophilic group, a diphenylamines-based coloring agent having a hydrophilic group, a triphenylamines-based coloring agent having a hydrophilic group, a quinone-based coloring agent having a hydrophilic group, and an azo-based coloring agent having a hydrophilic group) is as described above.

The phthalocyanine-based coloring agent having a hydrophilic group and the naphthalocyanine-based coloring agent having a hydrophilic group are coloring agents having a planar structure and having a wide π-conjugated plane.

The phthalocyanine-based coloring agent having a hydrophilic group preferably has a structure represented by Formula (1A), and the naphthalocyanine-based coloring agent having a hydrophilic group preferably has a structure represented by Formula (1).

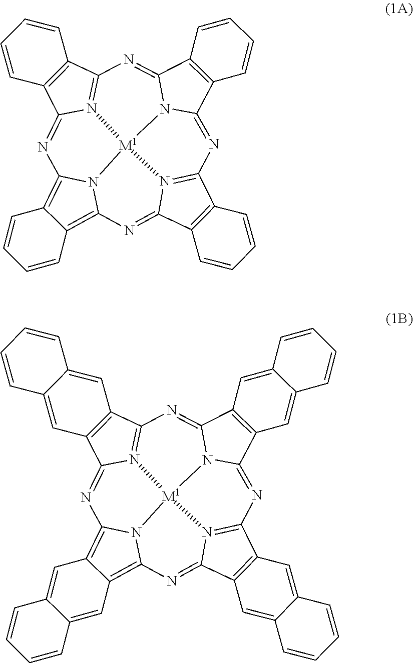

In Formula (1A) and Formula (1), M¹ represents a hydrogen atom, a metal atom, a metal oxide, a metal hydroxide, or a metal halide.
Examples of the metal atom include Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, and Bi.
Examples of the metal oxide include VO, GeO, and TiO.
Examples of the metal hydroxide include Si(OH)₂, Cr(OH)₂, Sn(OH)₂, and AlOH.
Examples of the metal halide include SiCl₂, VCl, VCl₂, VOCl, FeCl, GaCl, ZrCl, and AlCl.
Among these, a metal atom such as Fe, Co, Cu, Ni, Zn, Al, and V, a metal oxide such as VO, or a metal hydroxide such as AlOH is preferable, and a metal oxide such as VO is more preferable.

The phthalocyanine-based coloring agent having a hydrophilic group is preferably a compound represented by Formula (1A-1).

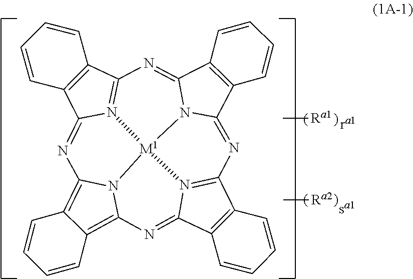

In Formula (1A-1), R^{a1} 's each independently represent a substituent having a hydrophilic group (hereinafter, also simply referred to as “specific substituent”). R^{a2}'s each independently represent a substituent not having a hydrophilic group.

The hydrophilic group included in the specific substituent is as described above.

The specific substituent is preferably a group represented by Formula (Z).

*-L^{a1}-(R^{a1})_{q} Formula (Z)

In Formula (Z), R^{a1} represents a hydrophilic group. The definition of the hydrophilic group is as described above.

In Formula (Z), in a case where q is 1, Lai represents a single bond or a divalent linking group, and in a case where q is 2 or more, L^{a1} represents a (q+1)-valent linking group.

Examples of the divalent linking group include a divalent hydrocarbon group (for example, a divalent aliphatic hydrocarbon group such as an alkenylene group (preferably having 1 to 10 carbon atoms and more preferably having 1 to 5 carbon atoms), an alkenylene group (preferably having 1 to 10 carbon atoms and more preferably having 1 to 5 carbon atoms), and an alkynylene group (preferably having 1 to 10 carbon atoms and more preferably having 1 to 5 carbon atoms), and a divalent aromatic hydrocarbon ring group such as an arylene group), a divalent heterocyclic group, —O—, —S—, —SO₂—, —NH—, —N(Q)-, —CO—, and a group obtained by combining these groups (for example, —O-divalent hydrocarbon group-, —(O-divalent hydrocarbon group)ₘ-O— (m represents an integer of 1 or more), -divalent hydrocarbon group-O—CO—, and the like). Q represents a hydrogen atom or an alkyl group.

In a case where q is 2 or more, examples of the (q+1)-valent linking group represented by L^{a1} include a trivalent linking group (q=2) and a tetravalent linking group (q=3).

Examples of the trivalent linking group include a residue formed by removing three hydrogen atoms from a hydrocarbon, a residue formed by removing three hydrogen atoms from a heterocyclic compound, and a group obtained by combining the residue and the above-described divalent linking group.

Examples of the tetravalent linking group include a residue formed by removing four hydrogen atoms from a hydrocarbon, a residue formed by removing four hydrogen atoms from a heterocyclic compound, and a group obtained by combining the residue and the above-described divalent linking group.
q represents an integer of 1 or more, and is preferably an integer of 1 to 4, more preferably 1 or 2, and still more preferably 1.

R^{a2}'s each independently represent a substituent not having a hydrophilic group. Examples of the above-described substituent not having a hydrophilic group include an alkyl group, an aryl group, and a heteroaryl group.

r^{a1} represents an integer of 1 or more, and is preferably an integer of 1 to 12 and more preferably an integer of 1 to 4.
s^{a1} represents an integer of 0 or more, and is preferably an integer of 0 to 4 and more preferably 0.

The naphthalocyanine-based coloring agent having a hydrophilic group is preferably a compound represented by Formula (1B-1).

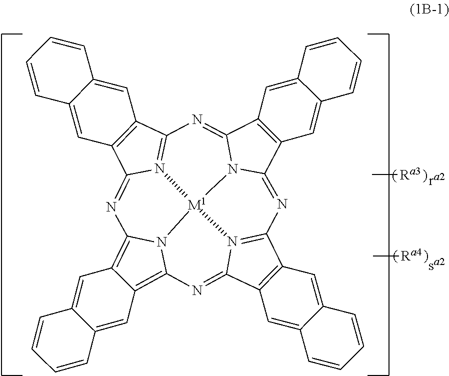

In Formula (1B-1), R^{a3}'s each independently represent a specific substituent. R^{a4}'s each independently represent a substituent not having a hydrophilic group.

The specific substituent represented by R^{a3} has the same meaning as the specific substituent represented by Rai.

The substituent not having a hydrophilic group, represented by R^{a4}, has the same meaning as the substituent not having a hydrophilic group, represented by R^{a2}.

r^{a2} represents an integer of 1 or more, and is preferably an integer of 1 to 12 and more preferably an integer of 1 to 4.
s^{a2} represents an integer of 0 or more, and is preferably an integer of 0 to 4 and more preferably 0.

The phthalocyanine-based coloring agent having a hydrophilic group is preferably the following compound example 1.

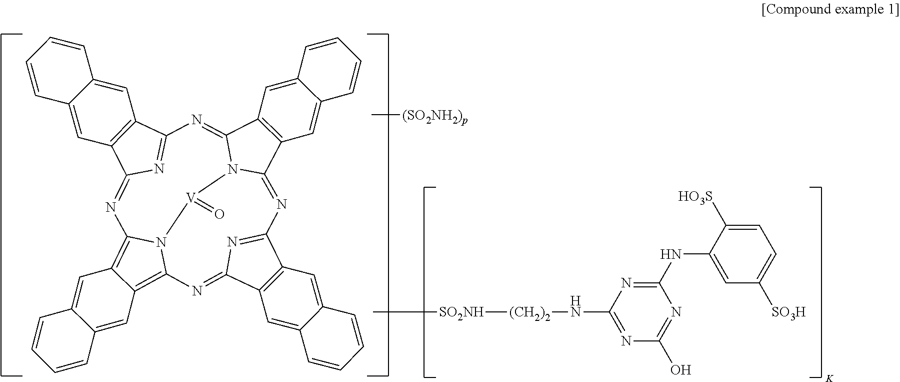

In the formula, p and k each independently represent an integer of 0 to 12, and the sum of p and k is 1 to 12. Among these, it is preferable that p is 1 to 4 and k is 0.

The quinone-based coloring agent having a hydrophilic group is a coloring agent having a wide range of absorption.

The quinone-based coloring agent having a hydrophilic group preferably has a structure represented by Formula (2).

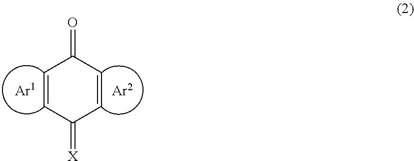

In Formula (2), X represents an oxygen atom or ═NR^{b}. R^{b} represents a hydrogen atom or a substituent. Examples of the substituent represented by R^{b} include groups exemplified by a substituent W described later.

Ar¹ and Ar² each independently represent an aromatic ring or a heterocyclic ring, and from the viewpoint of extending the absorption wavelength to a long wavelength side, a heterocyclic ring is preferable.

Since the quinone-based coloring agent has a hydrophilic group, the coloring agent can be dissolved in water. Examples of the quinone-based coloring agent having a hydrophilic group include indanthrene coloring agents as described in JP2006-508034A.

The quinone-based coloring agent is preferably a compound represented by Formula (2-1).

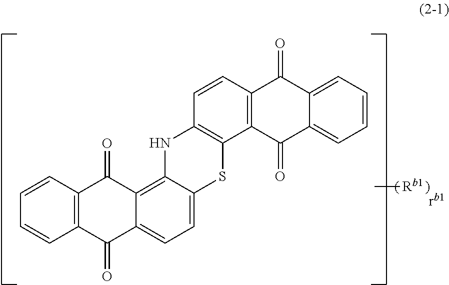

R^{b}'s each independently represent a specific substituent. The specific substituent is as described above. In particular, a specific substituent of q=1 is preferable. r^{b1} represents an integer of 1 to 12, and is preferably an integer of 1 to 4.

The quinone-based coloring agent having a hydrophilic group is preferably the following compound example 2.

### Compound Example 2

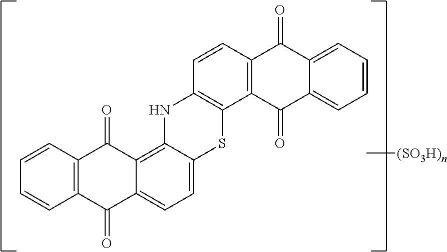

In the formula, n represents an integer of 1 to 12, and in a case where n is 1 or more, each sulfonic acid may be in a liberate form, in a salt for, or may include both the liberate form and the salt form in arbitrary ratio.

The cyanine-based coloring agent having a hydrophilic group is a coloring agent having strong absorption in a near-infrared region.

The cyanine-based coloring agent having a hydrophilic group is preferably a compound represented by Formula (3) or a compound represented by Formula (4).

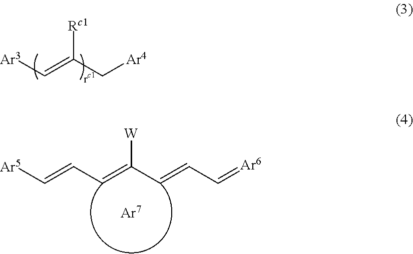

In Formula (3), Ar³ and Ar⁴ each independently represent a heterocyclic group which may have a specific substituent, and R represents a hydrogen atom or a substituent. However, at least one of Ar³ or Ar⁴ represents a heterocyclic group having a specific substituent.

The specific substituent included in the heterocyclic group represented by Ar³ and Ar⁴ is as described above.

Examples of a heterocyclic ring constituting the heterocyclic group include an indolenine ring, a benzoindolenine ring, an imidazole ring, a benzimidazole ring, a naphthimidazole ring, thiazole ring, a benzothiazole ring, a naphthothiazole ring, a thiazoline ring, an oxazole ring, a benzoxazole ring, a naphthoxazole ring, an oxazoline ring, a selenazole ring, a benzoselenazole ring, a naphthoselenazole ring, and a quinoline ring, and an indolenine ring, a benzoindolenine ring, a benzothiazole ring, or a naphthothiazole ring is preferable.

The specific substituent may be substituted on a heteroatom in the heterocyclic ring, or may be substituted on a carbon atom.

The heterocyclic group may have only one specific substituent, or may have a plurality of (for example, 2 or 3) specific substituents.

r^{c1} represents an integer of 1 to 7, and is preferably an integer of 3 to 5.

R^{c1} represents a hydrogen atom or a substituent. The type of the substituent is not particularly limited, examples thereof include known substituents, and an alkyl group which may have a substituent, an aryl group which may have a substituent, or a heteroaryl group which may have a substituent is preferable.

Examples of the substituent which may be included in the alkyl group, the aryl group, and the heteroaryl group include an alkyl group, an alkenyl group, an alkynyl group, an aryl group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfamoyl group, a carbamoyl group, an alkylthio group, an arylthio group, an aromatic heterocyclicthio group, a ureido group, a halogen atom, a cyano group, a nitro group, a heterocyclic group (for example, a heteroaryl group), a silyl group, and a group obtained by combining these groups (hereinafter, these groups are also collectively referred to as “substituent W”). The above-described substituent may be further substituted with the substituent W.

In Formula (4), Ar⁵ and Ar⁶ each independently represent a heterocyclic group which may have a specific substituent, Ar⁷ represents a cyclic skeleton having 5 to 7 carbon atoms, and W represents a hydrogen atom, a halogen atom, a methyl group, a phenyl group which may have a substituent, a benzyl group which may have a substituent, a pyridyl group, a morpholyl group, a piperidyl group, a phenylamino group which may have a substituent, a phenoxy group which may have a substituent, an alkylthio group which may have a substituent, or a phenylthio group which may have a substituent. However, at least one of Ar⁵ or Ar⁶ represents a heterocyclic group having a specific substituent.

The specific substituent included in the heterocyclic group represented by Ar⁵ and Ar⁶ is as described above.

Examples of a heterocyclic ring constituting the heterocyclic group include an indolenine ring, a benzoindolenine ring, an imidazole ring, a benzimidazole ring, a naphthimidazole ring, thiazole ring, a benzothiazole ring, a naphthothiazole ring, a thiazoline ring, an oxazole ring, a benzoxazole ring, a naphthoxazole ring, an oxazoline ring, a selenazole ring, a benzoselenazole ring, a naphthoselenazole ring, and a quinoline ring, and an indolenine ring, a benzoindolenine ring, a benzothiazole ring, or a naphthothiazole ring is preferable.

Examples of the substituent which may be included in the phenyl group, the benzyl group, the phenylamino group, the phenoxy group, the alkylthio group, and the phenylthio group represented by W include the groups exemplified by the substituent W described above and a hydrophilic group.

The number of carbon atoms in the alkylthio group represented by W is not particularly limited, but is preferably 1 to 5 and more preferably 1 to 3.

The compound represented by Formula (4) has an intramolecular salt type having a cation and an anion in one molecule or has an intermolecular salt type, and examples of the intermolecular salt type include a halide salt, perchlorate, fluoroantimonate, fluorophosphate, fluoroborate, trifluoromethanesulfonate, bis(trifluoromethane)sulfonic acid imide salt, and organic salts of naphthalene sulfonic acid or the like.

Specific examples thereof include indocyanine green and water-soluble coloring agents described in JP1988-033477A (JP-S63-033477A).

The compound represented by Formula (4) is preferably a compound represented by Formula (4-1).

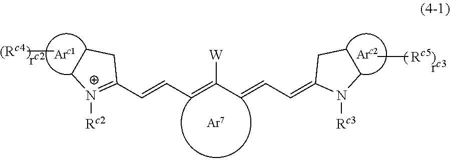

In Formula (4-1), R^{c2} to R^{c5} each independently a hydrogen atom or a substituent; any one of R^{c2} to R^{c5} represents a substituent having —SO₃ (for example, an alkyl group having —SO₃; the number of carbon atoms in the alkyl group is preferably 1 to 10), a substituent having —COO— (for example, an alkyl group having —COO—; the number of carbon atoms in the alkyl group is preferably 1 to 10), —SO₃—, or —COO—; Ar^{c1} and Ar^{c2} each independently represent an aromatic hydrocarbon ring (for example, a benzene ring or a naphthalene ring); Ar⁷ represents a cyclic skeleton having 5 to 7 carbon atoms; W represents a hydrogen atom, a halogen atom, a methyl group, a phenyl group which may have a substituent, a benzyl group which may have a substituent, a pyridyl group, a morpholyl group, a piperidyl group, a phenylamino group which may have a substituent, a phenoxy group which may have a substituent, an alkylthio group which may have a substituent, or a phenylthio group which may have a substituent; r^{c2} represents an integer of 1 to 3; and rc³ represents an integer of 1 to 3.

Examples of the substituent represented by R^{C2} to R^{c5} include the groups exemplified by the substituent W and the specific substituent.

Examples of the substituent which may be included in the phenyl group, the benzyl group, the phenylamino group, the phenoxy group, the alkylthio group, and the phenylthio group represented by W include the groups exemplified by the substituent W and the specific substituent.

Examples of the compound represented by Formula (3) and the compound represented by Formula (4) include compound examples 3 to 6.

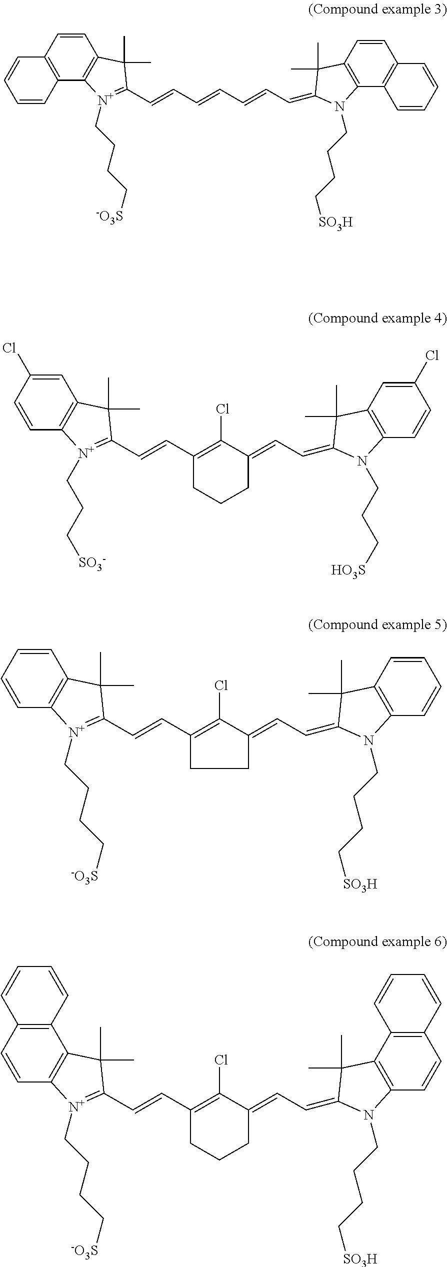

The squarylium-based coloring agent having a hydrophilic group is a coloring agent having a squaric acid in a central skeleton.

The squarylium-based coloring agent having a hydrophilic group is preferably a compound represented by Formula (5).

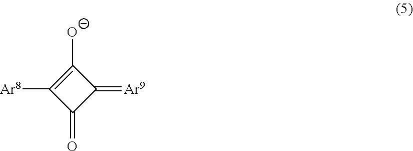

In Formula (5), Ar⁸ and Ar⁹ each independently represent a heterocyclic group which may have a specific substituent. Ar⁸ and Ar⁹ are preferably the above-described heterocyclic ring represented by Ar⁶.

The compound represented by Formula (5) also has an intramolecular salt type or an intermolecular salt type, and has a salt form same as the cyanine-based coloring agent.

The squarylium-based coloring agent having a hydrophilic group is preferably a compound represented by Formula (5-1) or a compound represented by Formula (5-2).

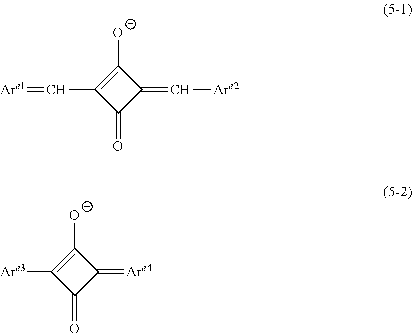

In Formula (5-1), Ar^{e1} represents a heterocyclic group which may have a specific substituent. Ar^{e2} represents a heterocyclic group including N⁺, which may have a specific substituent. However, at least one of the heterocyclic group represented by Ar^{e1} or the heterocyclic group represented by Ar^{e2} has the specific substituent.

In Formula (5-2), Ar^{e3} represents a heterocyclic group which may have a specific substituent. Ar^{e4} represents a heterocyclic group including N⁺, which may have a specific substituent. However, at least one of the heterocyclic group represented by Ar^{e3} or the heterocyclic group represented by Ar^{e4} has the specific substituent.

The azo-based coloring agent is a coloring agent absorbing a visible light region and is mainly used for a water-soluble ink. However, there also commercially available azo-based coloring agents which can absorb light in even near-infrared range because their absorption band has been widened.

Examples of the azo-based coloring agent include C. I. Acid Black 2 (manufactured by Orient Chemical Industries Co., Ltd.) and C. I. Direct Black 19 (manufactured by Aldrich Chemical Co., Ltd.) described in JP5979728B.

In addition, the azo-based coloring agent can also be formed in a complex with a metal atom. Examples of the complex including the azo-based coloring agent include a compound represented by Formula (6).

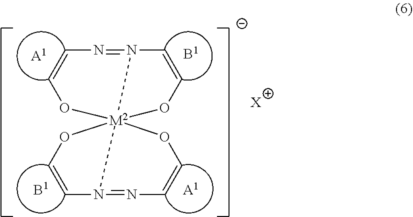

In Formula (6), M² represents a metal atom, and examples thereof include cobalt and nickel.

A¹ and B¹ each independently represent an aromatic ring which may have a specific substituent. However, any one of A¹ or B¹ represents an aromatic ring having a specific substituent.

Examples of the aromatic ring include a benzene ring and a naphthalene ring.

X⁺ represents a cation. Examples of the cation include H⁺, an alkali metal cation, and an ammonium cation.

Examples of the complex including the azo-based coloring agent include coloring agents described in JP1984-011385A (JP-S59-011385A).

Examples of the metal complex-based coloring agent include a compound represented by Formula (7) and a compound represented by Formula (8).

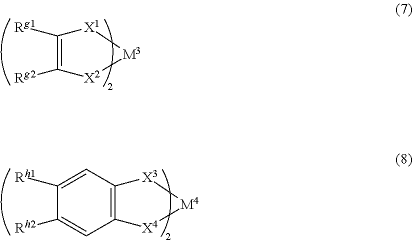

In Formula (7), M³ represents a metal atom, R^{g1} and R^{g2} each independently represent a hydrogen atom or a substituent, at least one of R^{g1} or R^{g2} represents a specific substituent, and X¹ and X² each independently represent an oxygen atom, a sulfur atom, or —NR^{g3}—. R^{g3} represents a hydrogen atom, an alkyl group, or an aryl group.

Examples of the metal atom represented by M³ include Pd, Ni, Co, and Cu, and Ni is preferable.

The type of the substituent represented by R^{g1} and R^{g2} is not particularly limited, and examples thereof include the groups exemplified by the substituent W described above and the specific substituent. At least one of R^{g1} or R^{g2} may represent the specific substituent or both R^{g1} and R^{g2} may represent the specific substituent.

In Formula (8), M⁴ represents a metal atom, R^{h1} and R^{h2} each independently represent a hydrogen atom or a substituent, at least one of R^{h1} or R^{h2} represents a specific substituent, and X³ and X⁴ each independently represent an oxygen atom, a sulfur atom, or —NR^{h3}—. R^{h3} represents a hydrogen atom, an alkyl group, or an aryl group.

Examples of the metal atom represented by M⁴ include Pd, Ni, Co, and Cu, and Ni is preferable.

The type of the substituent represented by R^{h1} and R^{h2} is not particularly limited, and examples thereof include the groups exemplified by the substituent W described above and the specific substituent. At least one of R^{h1} or R^{h2} may represent the specific substituent or both R^{h1} and R^{h2} may represent the specific substituent.

Examples of the boron complex-based coloring agent having a hydrophilic group include a compound represented by Formula (9).

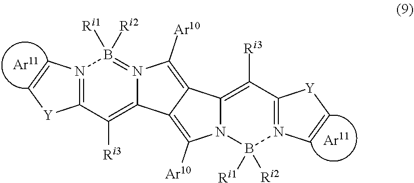

In Formula (9), Rⁱ¹ and Rⁱ² each independently represent a hydrogen atom, an alkyl group, or a phenyl group, Rⁱ³'s each independently represent an electron withdrawing group, Ar¹⁰'s each independently represent an aryl group which may have a specific substituent, at least one of two Ar¹⁰'s represents an aryl group having the specific substituent, Ar¹¹'s each independently represent an aromatic hydrocarbon ring or an aromatic heterocyclic ring, which may have a substituent, and Y represents a sulfur atom or an oxygen atom.

The electron withdrawing group represented by Rⁱ³ is not particularly limited, and represents a substituent having a positive Hammett's sigma para value (σp value), and examples thereof include a cyano group, an acyl group, an alkyloxycarbonyl group, an aryloxycarbonyl group, a sulfamoyl group, a sulfinyl group, and a heterocyclic group.

These electron withdrawing groups may be further substituted.

The Hammett's substituent constant σ value will be described. The Hammett's rule is an empirical rule advocated by L. P. Hammett in 1935 so as to quantitatively discuss the effect of substituent on the reaction or equilibrium of benzene derivatives and its propriety is widely admitted at present. Substituent constants obtained by the Hammett rule are an σp value and an am value, and these values can be found in many general books. For example, it is specifically described in Chem. Rev., 1991, vol. 91, pages 165 to 195. In the present invention, a substituent having the Hammett's substituent constant σp value of 0.20 or more is preferable as the electron withdrawing group. The σp value is preferably 0.25 or more, more preferably 0.30 or more, and still more preferably 0.35 or more. The upper limit thereof is not particularly limited, but is preferably 0.80 or less.

Specific examples thereof include a cyano group (0.66), a carboxyl group (—COOH: 0.45), an alkoxycarbonyl group (—COOMe: 0.45), an aryloxycarbonyl group (—COOPh: 0.44), a carbamoyl group (—CONH₂: 0.36), an alkylcarbonyl group (—COMe: 0.50), an arylcarbonyl group (—COPh: 0.43), an alkylsulfonyl group (—SO₂Me: 0.72), and an arylsulfonyl group (—SO₂Ph: 0.68).

The aryl group which may have a specific substituent represented by Ar¹⁰ is preferably a phenyl group which may have a specific substituent.

The definition of the specific substituent is as described above, and the aspect of q=1 is preferable.

The aromatic hydrocarbon ring in the aromatic hydrocarbon ring which may have a substituent, represented by Ar¹¹, is preferably a benzene ring or a naphthalene ring.

Examples of the substituent which may be included in the aromatic hydrocarbon ring and the aromatic heterocyclic ring represented by Ar¹¹ include the groups exemplified by the substituent W described above and the specific substituent.

The diimonium-based coloring agent having a hydrophilic group is a coloring agent having absorption on a relatively long wavelength side (950 to 1100 nm) even in a near-infrared region, and is preferably a compound represented by Formula (10).

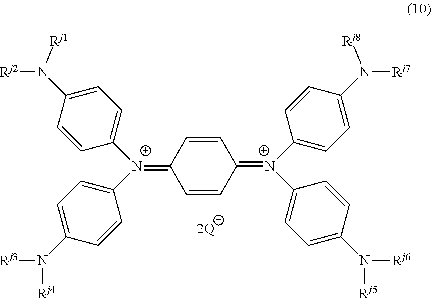

In Formula (10), R^{j1} to R^{j8} each independently an alkyl group which may have a substituent or an aromatic ring group which may have a substituent, and at least one of R^{j1} to R^{j8} represents an alkyl group having a specific substituent or an aromatic ring group having a specific substituent.

Q—represents an anion, and examples thereof include halide ions, perchlorate ions, fluoroantimonate ions, fluorophosphate ions, fluoroborate ions, trifluoromethanesulfonate ions, bis(trifluoromethane)sulfonic acid imide ions, and naphthalene sulfonic acid ions.

The oxonol-based coloring agent having a hydrophilic group is preferably a compound represented by Formula (11).

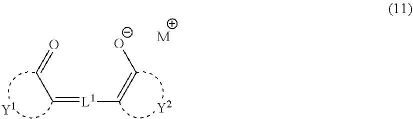

In Formula (11), Y¹ and Y² each independently represent an aliphatic ring or a non-metal atomic group forming a heterocyclic ring, M⁺ represents a proton, a monovalent alkali metal cation, or an organic cation, L¹ represents a methine chain consisting of 5 or 7 methine groups, and a methine group at the center of the methine chain has a substituent represented by Formula (A).

*—S^{A}-T^{A} Formula (A)

In Formula (A), S^{A} represents a single bond, an alkylene group, an alkenylene group, an alkynylene group, —O—, —S—, —NR^{L1}—, —C(═O)—, —C(═O)O—, —C(═O)NR^{L1}—, —S(═O)₂—, —OR^{L2}—, or a group obtained by combining these groups; R^{L1} represents a hydrogen atom, a halogen atom, an alkyl group, an aryl group, or a heteroaryl group; R^{L2} represents an alkylene group, an arylene group, or a divalent heterocyclic group; T^{A} represents a halogen atom, an alkyl group, a cycloalkyl group, an aryl group, a heteroaryl group, a cyano group, a hydroxy group, a formyl group, a carboxy group, an amino group, a thiol group, a sulfo group, a phosphoryl group, a boryl group, a vinyl group, an ethynyl group, a trialkylsilyl group, or a trialkoxysilyl group; in a case where S^{A} represents a single bond or an alkylene group and T^{A} represents an alkyl group, the total number of carbon atoms included in S^{A} and T^{A} is 3 or more; and * represents a bonding site with the central methine group of the methine chain.

The oxonol-based coloring agent having a hydrophilic group is more preferably a compound represented by Formula (12).

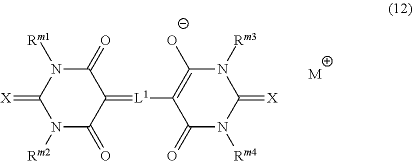

In Formula (12), M⁺ and L¹ are the same as M⁺ and L¹ in Formula (11).

R^{m1}, R^{m2}, R^{m3}, and R^{m4} each independently represent a hydrogen atom, an alkyl group, an aryl group, or a heteroaryl group, and X's each independently represent an oxygen atom, a sulfur atom, or a selenium atom.

The oxonol-based coloring agent having a hydrophilic group is still more preferably a compound represented by Formula (13).

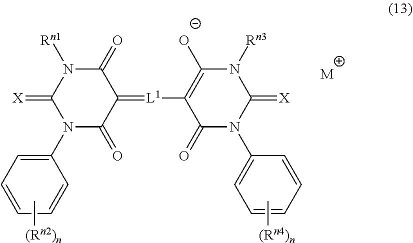

In Formula (13), M⁺, L¹, and X are the same as M⁺, L¹, and X in Formula (11).

Rⁿ¹ and Rⁿ³ each independently represent a hydrogen atom, an alkyl group, an aryl group, or a heteroaryl group; Rⁿ² and Rⁿ⁴ each independently represent an alkyl group, a halogen atom, an alkenyl group, an aryl group, a heteroaryl group, a nitro group, a cyano group, —OR^{L3}, —C(═O)R^{L3}, —C(═O)OR^{L3}, —OC(═O)R^{L3}, —N(R^{L3})₂, —NHC(═O)R^{L3}, —C(═O)N(R^{L3})₂, —NHC(═O)OR^{L3}, —OC(═O)N(R^{L3})₂, —NHC(═O)N(R^{L3})₂, —SR^{L3}—S(═O)₂R^{L3}, —S(═O)₂OR^{L3}, —NHS(═O)₂R^{L3}, or —S(═O)₂N(R^{L3})₂; R^{L3}'s each independently represent a hydrogen atom, an alkyl group, an alkenyl group, an aryl group, or a heteroaryl group; and n's each independently represent an integer of 1 to 5.

In the present specification, the term “rylene” refers to a compound having a molecular structure of a naphthalene unit bonded to a peri-position. Depending on the number of naphthalene units, the “rylene” may be, for example, perylene (n=2), terylene (n=3), quaterylene (n=4), or higher rylene.

The rylene-based formula is preferably a compound represented by Formula (14), a compound represented by Formula (15), or a compound represented by Formula (16).

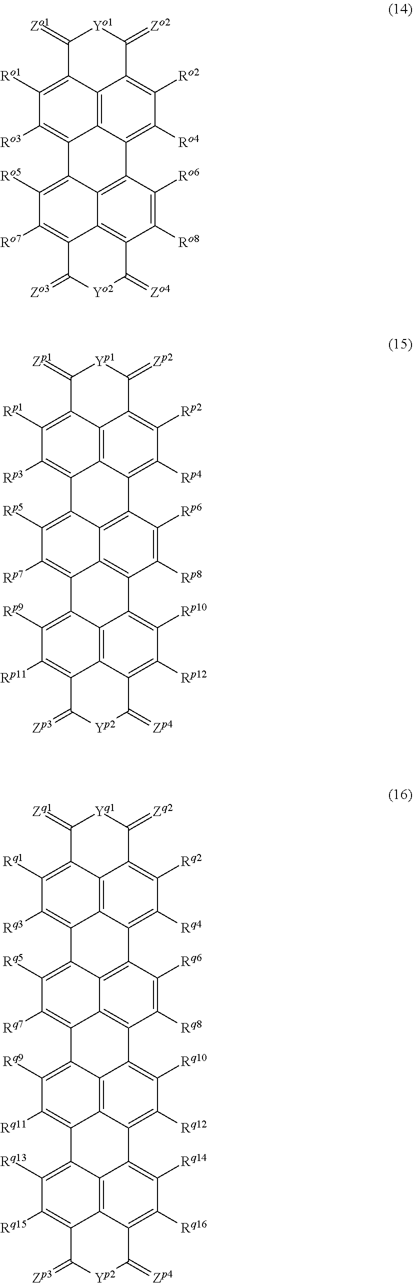

In Formula (14), Y^{o1} and Y^{o2} each independently represent an oxygen atom or NR^{w1}; R^{w1} represents a hydrogen atom or a substituent; Z^{o1} to Z^{o4} each independently represent an oxygen atom or NR^{W2}; R^{w2} represents a hydrogen atom or a substituent; R^{o1} to R^{o8} each independently represent a hydrogen atom or a substituent; and at least one of R^{o1} to R^{o8} represents a specific substituent, at least one of Y^{o1} or Y^{o2} is NR^{W1} in which R^{w1} is the specific substituent, or at least one of Z^{o1} to Z^{o4} is NR^{W2} in which R^{w2} is the specific substituent. R^{W1} and R^{W2} may be bonded to each other to form a ring which may have a substituent. In a case where the ring to be formed has two or more substituents, the substituents may be bonded to each other to form a ring (for example, an aromatic ring).

In Formula (15), Y^{p1} and Y^{p2} each independently represent an oxygen atom or NR^{w3}; R^{w3} represents a hydrogen atom or a substituent; Z^{p1} to Z^{p4} each independently represent an oxygen atom or NR^{W4}; R^{w4} represents a hydrogen atom or a substituent; R^{p1} to R^{p12} each independently represent a hydrogen atom or a substituent; and at least one of R^{p1} to Rp¹² represents a specific substituent, at least one of Y^{p1} or Y^{p2} is NR^{W3} in which R^{w3} is the specific substituent, or at least one of Z^{p1} to Z^{p4} is NR^{W4} in which R^{w4} is the specific substituent. R^{W3} and R^{W4} may be bonded to each other to form a ring which may have a substituent. In a case where the ring to be formed has two or more substituents, the substituents may be bonded to each other to form a ring (for example, an aromatic ring).

In Formula (16), Y^{q1} and Y^{q2} each independently represent an oxygen atom or NR^{w5}; R^{w}s represents a hydrogen atom or a substituent; Z^{q1} to Z⁴⁴ each independently represent an oxygen atom or NR^{W6}; R^{w6} represents a hydrogen atom or a substituent; R^{q1} to R^{g16} each independently represent a hydrogen atom or a substituent; and at least one of R^{g1} to R^{g16}, or R^{z} represents a specific substituent, at least one of Y^{q1} or Y^{q2} is NR^{W5} in which R^{w}s is the specific substituent, or at least one of Z^{q1} to Z^{q4} is NR^{W6} in which R^{w6} is the specific substituent. R^{W5} and R^{W6} may be bonded to each other to form a ring which may have a substituent. In a case where the ring to be formed has two or more substituents, the substituents may be bonded to each other to form a ring (for example, an aromatic ring).

It is preferable that the specific dichroic substance constitutes a J-aggregate. That is, it is preferable that the light absorption anisotropic film includes a J compound composed of the specific dichroic substance.

The J-aggregate is an aggregate of coloring agents. More specifically, the J-aggregate refers to a state in which coloring agent molecules are associated with each other with a constant deviation angle (slip angle). The J-aggregate has an absorption band with a narrow half-width and a high absorption light absorption coefficient on a long wavelength side as compared with a case of a single coloring agent molecule in a solution state. This sharpened absorption band is referred to as a J-band. The J-band is described in detail in literature (for example, Photographic Science and Engineering Vol 18, No 323-335 (1974)). Whether or not it is a J-aggregate can be easily determined by measuring its maximal absorption wavelength.

An absorption peak of the J-band is shifted to a long wavelength side with respect to the absorption peak of a single coloring agent molecule, and a difference between the wavelength of the absorption peak of the J-band and the wavelength of the absorption peak of the single coloring agent molecule is preferably 10 to 300 nm and more preferably 30 to 250 nm.

Absorption characteristics of the specific dichroic substance are not particularly limited, but it is preferable that the specific dichroic substance has a maximal absorption wavelength in a wavelength range of 700 to 1600 nm. The specific dichroic substance may have a plurality of maximal absorption wavelengths in a wavelength range of 700 to 1600 nm.

In a case where the specific dichroic substance forms the J-aggregate, it is preferable that the maximal absorption wavelength of the J-aggregate is located in the wavelength range of 700 to 1600 nm.

The specific dichroic substance may be used singly or in a combination of two or more kinds thereof.

In a case where two or more kinds of specific dichroic substances are contained in the light absorption anisotropic film, it is preferable to use at least a first specific dichroic substance having a maximal absorption wavelength in a wavelength range of 700 nm or more and less than 900 nm and a second specific dichroic substance having a maximal absorption wavelength in a wavelength range of 900 to 1600 nm.

As a measuring method of the above-described maximal absorption wavelength, using a solution prepared by dissolving the specific dichroic substance (5 to 50 mg) to be measured in a solution (for example, water, methanol, or dimethyl sulfoxide) (1000 ml) which dissolves the specific dichroic substance, an absorption spectrum is measured using a spectrophotometer (MPC-3100 (manufactured by SHIMADZU Corporation)), and the maximal absorption wavelength is read from the obtained absorption spectrum.

A content of the specific dichroic substance in the light absorption anisotropic film is not particularly limited, but from the absorption characteristics of the light absorption anisotropic film are more excellent, it is preferably 1% to 30% by mass and more preferably 3% to 15% by mass with respect to the total mass of the light absorption anisotropic film.

(Other Components)

The light absorption anisotropic film according to the embodiment of the present invention may contain a component other than the above-described specific dichroic substance.

(Non-Colorable Lyotropic Liquid Crystal Compound)

The light absorption anisotropic film may contain a non-colorable lyotropic liquid crystal compound. As will be described later, by using a composition containing the specific dichroic substance and the non-colorable lyotropic liquid crystal compound, the light absorption anisotropic film can be easily manufactured.

The non-coloring property means that no absorption is exhibited in the visible light region. More specifically, the non-coloring property means that the absorbance in a visible light range (wavelength of 400 to 700 nm) is 0.1 or less in a case of measuring the ultraviolet-visible absorption spectrum of the solution in which the lyotropic liquid crystal compound is dissolved at a concentration such that the absorbance at the maximum absorption wavelength in an ultraviolet light range (230 to 400 nm) is 1.0.

The lyotropic liquid crystal compound is a compound exhibiting lyotropic liquid crystallinity. The lyotropic liquid crystallinity refers to a property of causing a phase transition between an isotropic phase and a liquid crystal phase by changing a temperature or a concentration in a solution state of being dissolved in a solvent.

From the viewpoint that it is easy to control the expression of liquid crystallinity, the lyotropic liquid crystal compound is preferably water-soluble. The water-soluble lyotropic liquid crystal compound represents a lyotropic liquid crystal compound which is dissolved in water in an amount of 1% by mass or more, and a lyotropic liquid crystal compound which is dissolved in water in an amount of 5% by mass or more is preferable.

The type of the lyotropic liquid crystal compound is not particularly limited as long as the above-described light absorption anisotropic film can be formed. Among these, from the viewpoint of being able to form a light absorption anisotropic film with good productivity, the non-colorable lyotropic liquid crystal compound is preferably a non-colorable lyotropic liquid crystalline rod-like compound (hereinafter, also simply referred to as “rod-like compound”) or a non-colorable lyotropic liquid crystalline plate-like compound (hereinafter, also simply referred to as “plate-like compound”). As the non-colorable lyotropic liquid crystal compound, only the rod-like compound may be used, only the plate-like compound may be used, or the rod-like compound and the plate-like compound may be used in combination.

Hereinafter, the rod-like compound and the plate-like compound will be described in detail.

(Rod-Like Compound)

The light absorption anisotropic film may contain the rod-like compound. The rod-like compound tends to be aligned in a predetermined direction.

The rod-like compound exhibits lyotropic liquid crystallinity.

From the viewpoint that it is easy to control the expression of liquid crystallinity, the rod-like compound is preferably water-soluble. The water-soluble rod-like compound represents a rod-like compound which is dissolved in water in an amount of 1% by mass or more, and a rod-like compound which is dissolved in water in an amount of 5% by mass or more is preferable.

The rod-like compound refers to a compound having a structure in which ring structures (an aromatic ring, a non-aromatic ring, and the like) are one-dimensionally connected through a single bond or a divalent linking group, and refers to a group of compounds which have a property of aligning there major axes to each other in a solvent.

The rod-like compound preferably has a maximal absorption wavelength in a wavelength range of 300 nm or less. That is, the rod-like compound preferably has a maximal absorption peak in a wavelength range of 300 nm or less.

The maximal absorption wavelength of the above-described rod-like compound means a wavelength at which absorbance is the maximal value in an absorption spectrum of the rod-like compound (measurement range: wavelength range of 230 to 400 nm). In a case where there are a plurality of maximal values in the absorbance of the absorption spectrum of the rod-like compound, a wavelength on the longest wavelength side in the measurement range is selected.

Among these, from the viewpoint that aligning properties of the specific dichroic substance in the light absorption anisotropic film are more excellent, the rod-like compound preferably has a maximal absorption wavelength in a range of 230 to 300 nm, and more preferably has a maximal absorption wavelength in a range of 250 to 290 nm. As described above, the maximal absorption wavelength of the rod-like compound is preferably located at 250 nm or more.

A measuring method of the above-described maximal absorption wavelength is as follows.

The rod-like compound (5 to 50 mg) is dissolved in pure water (1000 ml), and using a spectrophotometer (MPC-3100 (manufactured by SHIMADZU Corporation)), an absorption spectrum of the obtained solution is measured.

From the viewpoint that aligning properties of the specific dichroic substance in the light absorption anisotropic film are more excellent, the rod-like compound preferably has a hydrophilic group.

The rod-like compound may have only one hydrophilic group, or may have a plurality of hydrophilic groups.

The definition of the hydrophilic group is the same as the definition of the hydrophilic group included in the specific dichroic substance, and a suitable aspect thereof is also the same.

From the viewpoint that aligning properties of the specific dichroic substance in the light absorption anisotropic film are more excellent, the rod-like compound is preferably a polymer having a repeating unit represented by Formula (X).

[symbol]

R^{x1}-L^{x1}-R^{x2}-L^{x2} [symbol] (X)

R^{x1} represents a divalent aromatic ring group having a substituent including a hydrophilic group, a divalent non-aromatic ring group having a substituent including a hydrophilic group, or a group represented by Formula (X1). In Formula (X1), * represents a bonding position.

*—R^{x3}-L^{x3}-R^{x4}—* Formula (X1)

R^{x3} and R^{x4} each independently represent a divalent aromatic ring group which may have a substituent including a hydrophilic group or a divalent non-aromatic ring group which may have a substituent including a hydrophilic group, and at least one of R^{x3} or R^{x4} represents a divalent aromatic ring group having a substituent including a hydrophilic group or a divalent non-aromatic ring group having a substituent including a hydrophilic group.

L^{x3} represents a single bond, —O—, —S—, an alkylene group, an alkenylene group, or an alkynylene group.

The divalent aromatic ring group and the divalent non-aromatic ring group represented by R^{x1} have a substituent including a hydrophilic group.

Examples of the hydrophilic group included in the substituent including a hydrophilic group include the groups exemplified by the hydrophilic group included in the specific dichroic substance described above, and an acid group or a salt thereof is preferable.

The substituent including a hydrophilic group is preferably a group represented by Formula (H). In Formula (H), * represents a bonding position.

R^{H}-L^{H}-* Formula (H)

R^{H} represents a hydrophilic group. The definition of the hydrophilic group is as described above.

L^{H} represents a single bond or a divalent linking group. The divalent linking group is not particularly limited, and examples thereof include a divalent hydrocarbon group (for example, a divalent aliphatic hydrocarbon group such as an alkylene group having 1 to 10 carbon atoms, an alkenylene group having 1 to 10 carbon atoms, or an alkynylene group having 1 to 10 carbon atoms, and a divalent aromatic hydrocarbon ring group such as an arylene group); a divalent heterocyclic group, —O—, —S—, —SO₂—, —NH—, —CO—, and a group obtained by combining these groups (for example, —CO—O—, —O-divalent hydrocarbon group-, —(O-divalent hydrocarbon group)ₘ-O— (m represents an integer of 1 or more), -divalent hydrocarbon group-O—CO—, and the like).

The number of substituents including a hydrophilic group in the divalent aromatic ring group is not particularly limited, but from the viewpoint that aligning properties of the specific dichroic substance in the light absorption anisotropic film are more excellent, it is preferably 1 to 3 and more preferably 1.

The number of substituents including a hydrophilic group in the divalent non-aromatic ring group is not particularly limited, but from the viewpoint that aligning properties of the specific dichroic substance in the light absorption anisotropic film are more excellent, it is preferably 1 to 3 and more preferably 1.

An aromatic ring constituting the divalent aromatic ring group having the substituent including a hydrophilic group, represented by R^{x1}, may have a monocyclic structure or a polycyclic structure.

Examples of the aromatic ring constituting the above-described divalent aromatic ring group include an aromatic hydrocarbon ring and an aromatic heterocyclic ring. That is, examples of R^{x1} include a divalent aromatic hydrocarbon ring group having the substituent including a hydrophilic group and a divalent aromatic heterocyclic group having the substituent including a substituent.

Examples of the aromatic hydrocarbon ring include a benzene ring and a naphthalene ring.

Examples of a structure of only the divalent aromatic hydrocarbon ring group portion of the divalent aromatic hydrocarbon ring group having the substituent including a hydrophilic group include the following group. * represents a bonding position.

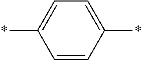 [SMILES: *c1ccc(*)cc1]

Examples of the aromatic heterocyclic ring include a pyridine ring, a thiophene ring, a pyrimidine ring, a thiazole ring, a furan ring, a pyrrole ring, an imidazole ring, and an indole ring.

Examples of a structure of only the divalent aromatic heterocyclic group portion of the divalent aromatic heterocyclic group having the substituent including a hydrophilic group include the following groups. * represents a bonding position.

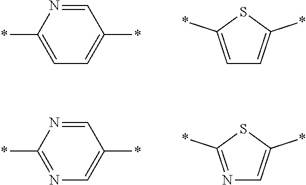 [SMILES: *c1ccc(*)nc1 ; *c1ccc(*)s1 ; *c1cnc(*)nc1 ; *c1cnc(*)s1]

A non-aromatic ring constituting the divalent non-aromatic ring group having the substituent including a hydrophilic group, represented by R^{x1}, may have a monocyclic structure or a polycyclic structure.

Examples of the non-aromatic ring constituting the above-described divalent non-aromatic ring group include an aliphatic ring and a non-aromatic heterocyclic ring, and from the viewpoint that aligning properties of the specific dichroic substance in the light absorption anisotropic film are more excellent, an aliphatic ring is preferable, cycloalkane is more preferable, and cyclohexane is still more preferable. That is, examples of R^{X1} include a divalent aliphatic ring group having a substituent including a hydrophilic group and a divalent non-aromatic heterocyclic group having a substituent including a hydrophilic group, and a divalent cycloalkylene group having a substituent including a hydrophilic group is preferable.

The aliphatic ring may be a saturated aliphatic ring or an unsaturated aliphatic ring.

Examples of a structure of only the divalent aliphatic ring group portion of the divalent aliphatic ring group having the substituent including a hydrophilic group include the following groups. * represents a bonding position.

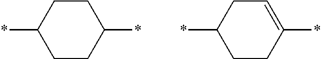

A heteroatom included in the non-aromatic heterocyclic ring is not particularly limited, and examples thereof include an oxygen atom, a nitrogen atom, and a sulfur atom.

The number of heteroatoms included in the non-aromatic heterocyclic ring is not particularly limited, and examples thereof include 1 to 3.

Examples of a structure of only the divalent non-aromatic heterocyclic group portion of the divalent non-aromatic heterocyclic group having the substituent including a hydrophilic group include the following group. * represents a bonding position.

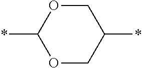 [SMILES: *C1COC(*)OC1]

The divalent aromatic ring group having a substituent including a hydrophilic group and the divalent non-aromatic ring group having a substituent including a hydrophilic group, represented by R^{x1}, may have a substituent other than the substituent including a hydrophilic group.

The substituent is not particularly limited, and examples thereof include an alkyl group, an alkenyl group, an alkynyl group, an aryl group, an amino group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, an alkylthio group, an arylthio group, an aromatic heterocyclic thio group, a ureido group, a halogen atom, a cyano group, a hydrazino group, a heterocyclic group (for example, a heteroaryl group), a silyl group, and a group obtained by combining there groups. The above-described substituent may be further substituted with a substituent.

R^{x3} and R^{x4} each independently represent a divalent aromatic ring group which may have a substituent including a hydrophilic group or a divalent non-aromatic ring group which may have a substituent including a hydrophilic group, and at least one of R^{x3} or R^{x4} represents a divalent aromatic ring group having a substituent including a hydrophilic group or a divalent non-aromatic ring group having a substituent including a hydrophilic group.

The definition of the substituent including a hydrophilic group, which may be included in the divalent aromatic ring group represented by R^{x3} and R^{x4}, is as described above.

In addition, the definition of the aromatic ring constituting the divalent aromatic ring group, which may have the substituent including a hydrophilic group and is represented by R^{x3} and R^{x4}, is the same as the definition of the aromatic ring constituting the above-described divalent aromatic ring group having the substituent including a hydrophilic group, represented by R^{x1}.

The definition of the substituent including a hydrophilic group, which may be included in the divalent non-aromatic ring group represented by R^{x3} and R^{x4}, is as described above.

In addition, the definition of the non-aromatic ring constituting the divalent non-aromatic ring group, which may have the substituent including a hydrophilic group and is represented by R^{x3} and R^{x4}, is the same as the definition of the non-aromatic ring constituting the above-described divalent non-aromatic ring group having the substituent including a hydrophilic group, represented by R^{x1}.

At least one of R^{x3} or R^{x4} represents a divalent aromatic ring group having a substituent including a hydrophilic group or a divalent non-aromatic ring group having a substituent including a hydrophilic group, and both R^{x3} and R^{x4} represent the divalent aromatic ring group having a substituent including a hydrophilic group or the divalent non-aromatic ring group having a substituent including a hydrophilic group.

The definition of the divalent aromatic ring group having the substituent including a hydrophilic group, represented by R^{x3} and R^{x4}, has the same meaning as the above-described divalent aromatic ring group having the substituent including a hydrophilic group, represented by R^{x1}.

In addition, the definition of the divalent non-aromatic ring group having the substituent including a hydrophilic group, represented by R^{x3} and R^{x4}, has the same meaning as the above-described divalent non-aromatic ring group having the substituent including a hydrophilic group, represented by R^{x1}.

L^{x3} represents a single bond, —O—, —S—, an alkylene group, an alkenylene group, or an alkynylene group.

The number of carbon atoms in the alkylene group is not particularly limited, but from the viewpoint that aligning properties of the specific dichroic substance in the light absorption anisotropic film are more excellent, it is preferably 1 to 3 and more preferably 1.

The number of carbon atoms in the alkenylene group and the alkynylene group is not particularly limited, but from the viewpoint that the alignment of the specific dichroic substance in the light absorption anisotropic film is more excellent, it is preferably 2 to 5 and more preferably 2 to 4.

R^{x2} represents a divalent non-aromatic ring group, a divalent aromatic ring group, or a group represented by Formula (X2). In Formula (X2), * represents a bonding position.

*—Z^{x1}—Z^{x2}—* Formula (X2)

Z^{x1} and Z² each independently represent a divalent non-aromatic ring group or a divalent aromatic ring group. * represents a bonding position.

A non-aromatic ring constituting the divalent non-aromatic ring group represented by R^{x2} may have a monocyclic structure or a polycyclic structure.

Examples of the non-aromatic ring constituting the above-described divalent non-aromatic ring group include an aliphatic ring and a non-aromatic heterocyclic ring, and from the viewpoint that aligning properties of the specific dichroic substance in the light absorption anisotropic film are more excellent, an aliphatic ring is preferable, cycloalkane is more preferable, and cyclohexane is still more preferable. That is, examples of R^{x2} include a divalent aliphatic ring group and a divalent non-aromatic heterocyclic group, and a divalent cycloalkylene group is preferable.

The aliphatic ring may be a saturated aliphatic ring or an unsaturated aliphatic ring.

Examples of the divalent aliphatic ring group include the following groups. * represents a bonding position.

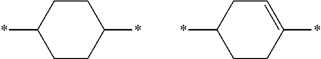

A heteroatom included in the non-aromatic heterocyclic ring is not particularly limited, and examples thereof include an oxygen atom, a nitrogen atom, and a sulfur atom.

The number of heteroatoms included in the non-aromatic heterocyclic ring is not particularly limited, and examples thereof include 1 to 3.

Examples of the divalent non-aromatic heterocyclic group include the following group. * represents a bonding position.

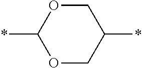 [SMILES: *C1COC(*)OC1]

The divalent non-aromatic ring group may have a substituent. The type of the substituent is not particularly limited, and examples thereof include the groups exemplified by the substituent other than the substituent including a hydrophilic group, which may be included in the divalent aromatic ring group having the substituent including a hydrophilic group or the divalent non-aromatic ring group having the substituent including a hydrophilic group, represented by R^{x1}.

An aromatic ring constituting the divalent aromatic ring group represented by R^{x2} may have a monocyclic structure or a polycyclic structure.

Examples of the aromatic ring include an aromatic hydrocarbon ring and an aromatic heterocyclic ring.

Examples of the aromatic hydrocarbon ring include a benzene ring and a naphthalene ring.

Examples of the aromatic heterocyclic ring include a pyridine ring, a thiophene ring, a pyrimidine ring, a thiazole ring, a furan ring, a pyrrole ring, an imidazole ring, and an indole ring.

The divalent aromatic ring group may have a substituent. The type of the substituent is not particularly limited, and examples thereof include the groups exemplified by the substituent other than the substituent including a hydrophilic group, which may be included in the divalent aromatic ring group having the substituent including a hydrophilic group or the divalent non-aromatic ring group having the substituent including a hydrophilic group, represented by R^{x1}.

Z^{x1} and Z^{x2} each independently represent a divalent non-aromatic ring group or a divalent aromatic ring group.

The definition of the divalent non-aromatic ring group represented by Z^{x1} and Z^{x2} and the definition of the divalent aromatic ring group are the same as the definition of the divalent non-aromatic ring group represented by R^{x2} and the definition of the divalent aromatic ring group described above.

L^{x1} and L^{x2} each independently represent —CONH—, —COO—, —O—, or —S—. Among these, from the viewpoint that the aligning properties of the specific dichroic substance are more excellent, —CONH— is preferable.

The repeating unit represented by Formula (X) is preferably a repeating unit represented by Formula (X4).

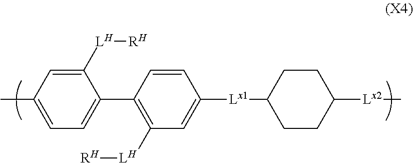

The definition of each group in Formula (X4) is as described above.

A content of the repeating unit represented by Formula (X) included in the polymer having the repeating unit represented by Formula (X) is not particularly limited, but is preferably 60% by mole or more and more preferably 80% by mole or more with respect to all repeating units in the polymer. The upper limit thereof is, for example, 100% by mass.

A molecular weight of the polymer having the repeating unit represented by Formula (X) is not particularly limited, and the number of repeating units represented by Formula (X) in the polymer is preferably 2 or more, more preferably 10 to 100,000, and still more preferably 100 to 10,000.

In addition, a number-average molecular weight of the polymer having the repeating unit represented by Formula (X) is not particularly limited, but is preferably 5,000 to 50,000 and more preferably 10,000 to 30,000.

In addition, a molecular weight distribution of the polymer having the repeating unit represented by Formula (X) is not particularly limited, but is preferably 1.0 to 12.0 and more preferably 1.0 to 7.0.

Here, the number-average molecular weight and the molecular weight distribution in the present invention are values measured by a gel permeation chromatography (GPC) method.
Solvent (eluent): 20 mM phosphate (pH: 7.0)/acetonitrile=4/1
Device name: TOSOH HLC-8220GPC
Column: using three columns of G6000PWxL, 4500PWxL, and G2500pWwL manufactured by Tosoh Corporation connected with each other
Column temperature: 40° C.
Sample concentration: 2 mg/mL
Flow rate: 1 mL/min
Calibration curve: calibration curve using 8 samples up to polystyrene sulfonic acid (PSS) Mp=891, 4200, 10200, 29500, 78400, 152000, 258000, and 462000

(Plate-Like Compound)

The light absorption anisotropic film may contain the plate-like compound.

The “plate-like compound” refers to a compound having a structure in which aromatic rings (an aromatic hydrocarbon ring, an aromatic heterocyclic ring, and the like) are spread two-dimensionally through a single bond or an appropriate linking group, and refers to a group of compounds which have a property of forming column-like associate by associating planes in the compound in a solvent.

The plate-like compound exhibits lyotropic liquid crystallinity.

From the viewpoint that it is easy to control the expression of liquid crystallinity, the plate-like compound is preferably water-soluble. The water-soluble plate-like compound represents a plate-like compound which is dissolved in water in an amount of 1% by mass or more, and a plate-like compound which is dissolved in water in an amount of 5% by mass or more is preferable.

The plate-like compound preferably has a maximal absorption wavelength in a wavelength range of more than 300 nm. That is, the plate-like compound preferably has a maximal absorption peak in a wavelength range of more than 300 nm.

The maximal absorption wavelength of the above-described plate-like compound means a wavelength at which absorbance is the maximal value in an absorption spectrum of the plate-like compound (measurement range: wavelength range of 230 to 400 nm). In a case where there are a plurality of maximal values in the absorbance of the absorption spectrum of the plate-like compound, a wavelength on the longest wavelength side in the measurement range is selected.

Among these, the plate-like compound preferably has a maximal absorption wavelength in a range of 320 to 400 nm, and more preferably has a maximal absorption wavelength in a range of 330 to 360 nm.

A measuring method of the above-described maximal absorption wavelength is as follows.

The plate-like compound (0.01 to 0.05 mmol) is dissolved in pure water (1000 ml), and using a spectrophotometer (MPC-3100 (manufactured by SHIMADZU Corporation)), an absorption spectrum of the obtained solution is measured.

From the viewpoint that aligning properties of the specific dichroic substance in the light absorption anisotropic film are more excellent, the plate-like compound preferably has a hydrophilic group.

The definition of the hydrophilic group is the same as the definition of the hydrophilic group which may be included in the rod-like compound.

The plate-like compound may have only one hydrophilic group, or may have a plurality of hydrophilic groups. In a case where the plate-like compound has a plurality of hydrophilic groups, the number thereof is preferably 2 to 4 and more preferably 2.

From the viewpoint that aligning properties of the specific dichroic substance in the light absorption anisotropic film are more excellent, the plate-like compound is preferably a compound represented by Formula (Y).

R^{y2}-L^{y3}-L^{y1}-R^{y1}-L^{y2}-L^{y4}-R^{y3} Formula (Y)

R^{y1} represents a divalent monocyclic group or a divalent fused polycyclic group.

Examples of a ring included in the divalent monocyclic group include a monocyclic hydrocarbon ring and a monocyclic heterocyclic ring. The monocyclic hydrocarbon ring may be a monocyclic aromatic hydrocarbon ring or a monocyclic non-aromatic hydrocarbon ring. The monocyclic heterocyclic ring may be a monocyclic aromatic heterocyclic ring or a monocyclic non-aromatic heterocyclic ring.

From the viewpoint that aligning properties of the specific dichroic substance in the light absorption anisotropic film are more excellent, the divalent monocyclic group is preferably a divalent monocyclic aromatic hydrocarbon ring group or a divalent monocyclic aromatic heterocyclic group.

The number of ring structures included in the divalent fused polycyclic group is not particularly limited, but from the viewpoint that aligning properties of the specific dichroic substance in the light absorption anisotropic film are more excellent, it is preferably 3 to 10, more preferably 3 to 6, and still more preferably 3 or 4.

Examples of the ring included in the divalent fused polycyclic group include a hydrocarbon ring and a heterocyclic ring. The hydrocarbon ring may be an aromatic hydrocarbon ring or a non-aromatic hydrocarbon ring. The heterocyclic ring may be an aromatic heterocyclic ring or a non-aromatic heterocyclic ring.

From the viewpoint that the aligning properties of the dichroic substance are more excellent, the divalent fused polycyclic group is preferably composed of an aromatic hydrocarbon ring and a heterocyclic ring. The divalent fused polycyclic group is preferably a conjugated linking group. That is, the divalent fused polycyclic group is preferably a conjugated divalent fused polycyclic group.

Examples of the ring constituting the divalent fused polycyclic group include dibenzothiophene-S,S-dioxide (a ring represented by Formula (Y2)), dinaphtho[2,3-b:2′,3′-d]furan (a ring represented by Formula (Y3)), 12H-benzo“b”phenoxazine (a ring represented by Formula (Y4)), dibenzo[b,i]oxantrene (a ring represented by Formula (Y5)), benzo[b]naphtho[2′,3′:5,6]dioxino[2,3-i]oxantrene (a ring represented by Formula (Y6)), acenaphtho[1,2-b]benzo[g]quinoxaline (a ring represented by Formula (Y7)), 9H-acenaphtho[1,2-b]imidazo[4,5-g]quinoxaline (a ring represented by Formula (Y8)), dibenzo[b,def]chrysene-7,14-dione (a ring represented by Formula (Y9)), and acetonaphthoquinoxaline (a ring represented by Formula (Y10)).

That is, examples of the divalent fused polycyclic group include divalent groups formed by removing two hydrogen atoms from the rings represented by Formulae (Y2) to (Y10).

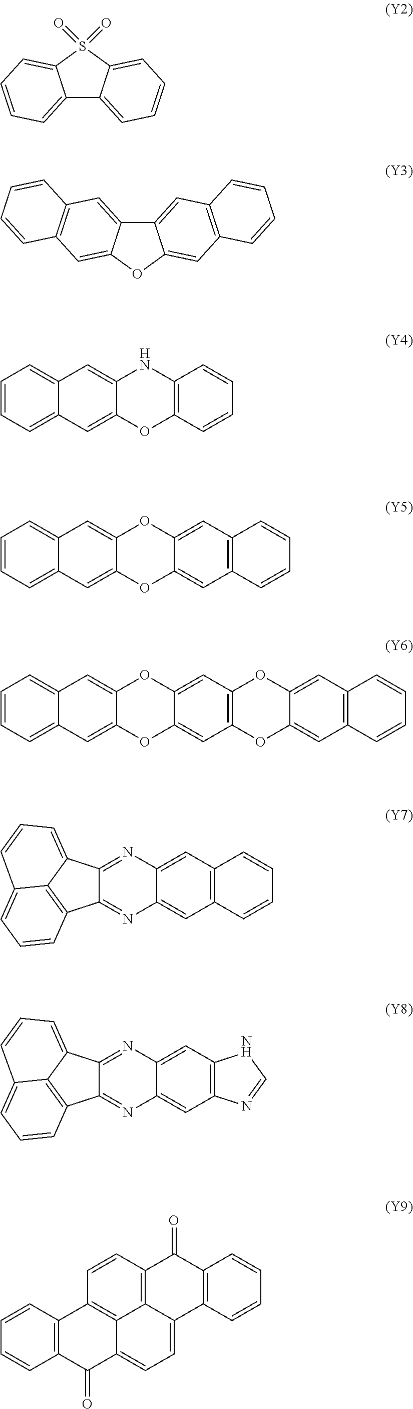

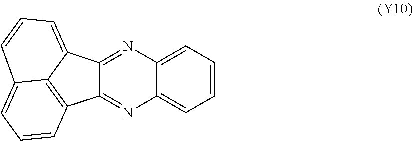 [SMILES: c1cc2c3c(cccc3c1)-c1nc3ccccc3nc1-2]

The divalent monocyclic group and the divalent fused polycyclic group may have a substituent. The type of the substituent is not particularly limited, and examples thereof include the groups exemplified by the substituent other than the substituent including a hydrophilic group, which is included in the divalent aromatic ring group having the substituent including a hydrophilic group or the divalent non-aromatic ring group having the substituent including a hydrophilic group, represented by R^{X}.

R^{y2} and R^{y3} each independently represent a hydrogen atom or a hydrophilic group, and at least one of R^{y2} or R^{y3} represents a hydrophilic group. It is preferable that both R^{y2} and R^{y3} represent a hydrophilic group.

The definition of the hydrophilic group represented by R^{y2} and R^{y3} is as described above.

L^{y1} and L^{y2} each independently represent a single bond, a divalent aromatic ring group, or a group represented by Formula (Y1). However, in a case where R^{y1} is a divalent monocyclic group, both L^{y1} and L² represent a divalent aromatic ring group or a group represented by Formula (Y1). In Formula (Y1), * represents a bonding position.

*—R^{y4}—(R^{y5})ₙ—* Formula (Y1)

R^{y4} and R^{y5} each independently represent a divalent aromatic ring group.

n represents 1 or 2.

An aromatic ring constituting the divalent aromatic ring group represented by L^{y1} and L^{y2} may have a monocyclic structure or a polycyclic structure.

Examples of the aromatic ring constituting the above-described divalent aromatic ring group include an aromatic hydrocarbon ring and an aromatic heterocyclic ring. That is, examples of the divalent aromatic ring group represented by L^{y1} and L^{y2} include a divalent aromatic hydrocarbon ring group and a divalent aromatic heterocyclic group.

Examples of the aromatic hydrocarbon ring include a benzene ring and a naphthalene ring.

Examples of the divalent aromatic hydrocarbon ring group include the following group. * represents a bonding position.

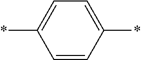 [SMILES: *c1ccc(*)cc1]

Examples of the aromatic heterocyclic ring include a pyridine ring, a thiophene ring, a pyrimidine ring, a thiazole ring, a furan ring, a pyrrole ring, an imidazole ring, and an indole ring.

Examples of the divalent aromatic heterocyclic group include the following groups. * represents a bonding position.

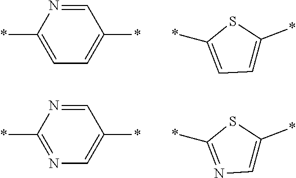

The definition of the divalent aromatic ring group represented by R^{y4} and R^{y5} is also the same as the divalent aromatic ring group represented by L^{y1} and L^{y2}.

L^{y3} and L^{y4} each independently represent a single bond, —O—, —S—, an alkylene group, an alkenylene group, an alkynylene group, or a group obtained by combining these groups.

Examples of the above-described group obtained by combining these groups include —O-alkylene group- and —S-alkylene group-.

The number of carbon atoms in the alkylene group is not particularly limited, but from the viewpoint that aligning properties of the specific dichroic substance in the light absorption anisotropic film are more excellent, it is preferably 1 to 3 and more preferably 1.

The number of carbon atoms in the alkenylene group and the alkynylene group is not particularly limited, but from the viewpoint that the aligning properties of the specific dichroic substance in the light absorption anisotropic film are more excellent, it is preferably 2 to 5 and more preferably 2 to 4.

(Salt)

The light absorption anisotropic film may contain a salt.

In a case where the plate-like compound has an acid group or a salt thereof, by containing a salt in the light absorption anisotropic film, planes in the plate-like compound are more likely to associate with each other, and column-like aggregates are likely to be formed.

The above-described salt does not include the rod-like compound and the plate-like compound described above. That is, the above-described salt is a compound different from the rod-like compound and the plate-like compound described above.

The salt is not particularly limited and may be an organic salt or an inorganic salt, but from the viewpoint that aligning properties of the specific dichroic substance in the light absorption anisotropic film are more excellent, an inorganic salt is preferable. Examples of the inorganic salt include an alkali metal salt, an alkaline earth metal salt, and a transition metal salt, and from the viewpoint that aligning properties of the specific dichroic substance in the light absorption anisotropic film are more excellent, an alkali metal salt is preferable.

The alkali metal salt is a salt in which a cation is an alkali metal ion, and the alkali metal salt is preferably lithium ion or sodium ion, and more preferably lithium ion. That is, as the salt, a lithium salt or a sodium salt is preferable, and a lithium salt is more preferable.

Examples of the alkali metal salt include hydroxides of an alkali metal, such as lithium hydroxide, sodium hydroxide, and potassium hydroxide; carbonates of an alkali metal, such as lithium carbonate, sodium carbonate, and potassium carbonate; and bicarbonates of an alkali metal, such as lithium bicarbonate, sodium bicarbonate, and potassium bicarbonate.

In addition to the above, the alkali metal salt may be, for example, a phosphate or a chloride.

Examples of an anion of the above-described salt include a hydroxide ion, a carbonate ion, a chloride ion, a sulfate ion, a nitrate ion, a phosphate ion, a borate ion, a tetrafluoroborate ion, a hexafluorophosphate ion, a perchlorate ion, a toluenesulfonate ion, an oxalate ion, a formate ion, a trifluoroacetate ion, a trifluoromethanesulfonate ion, a hexafluorophosphate ion, a bis(fluoromethanesulfonyl)imide ion, a bis(pentafluoroethanesulfonyl)imide ion, and a bis(trifluoromethanesulfonyl)imide ion.

In a case where the plate-like compound has a salt of an acid group, it is preferable that the cation in the salt of an acid group and the cation in the salt used are of the same type.

<Characteristics of Light Absorption Anisotropic Film>

The light absorption anisotropic film has a maximal absorption wavelength in a wavelength range of 700 to 1600 nm (hereinafter, also simply referred to as “specific maximal absorption wavelength”). Since the light absorption anisotropic film has the maximal absorption wavelength in the above-described range, the light absorption anisotropic film can absorb near-infrared rays in the wavelength range of 700 to 1600 nm. As a result, the light absorption anisotropic film can be used as a light absorption anisotropic film having absorption in a near-infrared region. In particular, it is preferable that the light absorption anisotropic film according to the embodiment of the present invention is a film having different absorbances depending on directions with respect to light having any one wavelength of 700 to 1600 nm.

It is preferable that the light absorption anisotropic film has a first maximal absorption wavelength in a wavelength range of 700 nm or more and less than 900 nm and a second maximal absorption wavelength in a wavelength range of 900 to 1600 nm.

Absorption characteristics of the light absorption anisotropic film as described above can be achieved by using the specific dichroic substance having a maximal absorption wavelength in the above-described wavelength range.

In the light absorption anisotropic film, the specific dichroic substance may be in various alignment states.

Examples of the alignment state include a homogeneous alignment and a homeotropic alignment. More specific examples of the alignment state include a nematic alignment (state of forming a nematic phase), a smectic alignment (state of forming a smectic phase), a twisted alignment, a cholesteric alignment (state of forming a cholesteric phase), and a hybrid alignment.

Examples of a method of achieving the alignment state of the specific dichroic substance as described above include a method using a liquid crystal compound (for example, the non-colorable lyotropic liquid crystal compound described above). That is, in a case where the light absorption anisotropic film contains a liquid crystal compound, by aligning the liquid crystal compound in the predetermined alignment state described above, the specific dichroic substance can also be aligned in accordance with the alignment state.

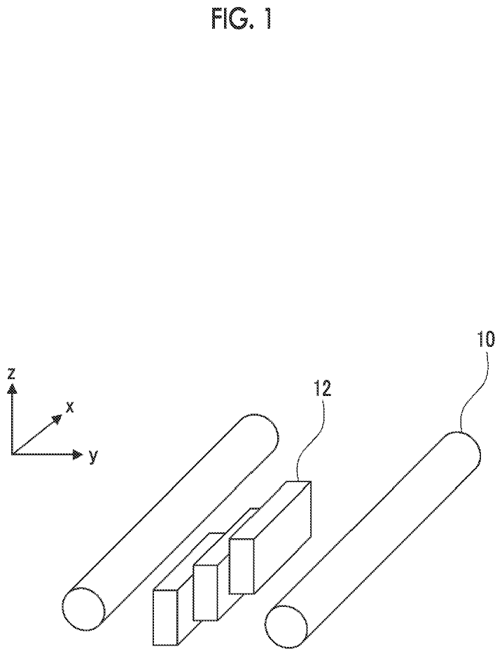

For example, FIG. 1 shows a schematic view in a case of using the rod-like compound. In particular, FIG. 1 shows, as an example, an aspect in which the light absorption anisotropic film contains a rod-like compound 10, and molecular axes of the rod-like compounds 10 are arranged along an X-axis direction. As will be described later, a method of achieving the arrangement state of the rod-like compounds 10 as described above can be achieved by applying a composition containing the rod-like compound 10 and applying a shearing force along the X-axis direction. As described above, since the specific dichroic substance can form a J-aggregate, in a case where the rod-like compounds 10 are arranged as shown in FIG. 1, specific dichroic substances 12 having a plate-like structure are arranged so that main surfaces face each other to form the J-aggregate, and directions of the main surfaces of the specific dichroic substances 12 are arranged along the X-axis direction. That is, as shown in FIG. 1, an alignment direction of the specific dichroic substance can be adjusted by aligning the rod-like compound.

Although the case where the specific dichroic substance forms the J-aggregate is described as the example of FIG. 1, in the light absorption anisotropic film according to the embodiment of the present invention, the specific dichroic substance may not form the J-aggregate.

The light absorption anisotropic film preferably has an absorption axis at the specific maximal absorption wavelength in an in-plane direction. In such an aspect, this can be achieved by homogeneously aligning the specific dichroic substance having absorption at the specific maximal absorption wavelength in the light absorption anisotropic film (arranging a major axis direction of the specific dichroic substance horizontally and in the same direction with respect to the surface of the light absorption anisotropic film).

In addition, the light absorption anisotropic film also preferably has an absorption axis at the specific maximal absorption wavelength along a thickness direction. In such an aspect, this can be achieved by homeotropically aligning the specific dichroic substance having absorption at the specific maximal absorption wavelength in the light absorption anisotropic film (arranging a major axis direction of the specific dichroic substance perpendicular to the surface of the light absorption anisotropic film).

An alignment degree of the specific dichroic substance in the light absorption anisotropic film is not particularly limited, but from the absorption characteristics of the light absorption anisotropic film are more excellent, it is preferably 0.60 or more, more preferably 0.80 or more, and still more preferably 0.90 or more. The upper limit thereof is not particularly limited, but may be, for example, 1.00.

The above-described alignment degree is an alignment degree measured by the maximal absorption wavelength of the specific dichroic substance in the light absorption anisotropic film.

In a case where the specific dichroic substance forms the J-aggregate in the light absorption anisotropic film, the alignment degree is measured using the maximal absorption wavelength derived from the J-aggregate.

In a case where the specific dichroic substance is homogeneously aligned in the light absorption anisotropic film (in other words, in a case of having an absorption axis in the in-plane direction), the above-described alignment degree is calculated by the following method.

Using an ultraviolet-visible-near infrared spectrophotometer V-660 including an automatic absolute reflectivity measuring unit ARMN-735, manufactured by Jasco Corporation, the absorbance of the light absorption anisotropic film is measured to calculate the alignment degree from the following expression.

Alignment degree:S=[(Az0/Ay0)−1]/[(Az0/Ay0)+2]

Az0: absorbance of the specific dichroic substance in an absorption axis direction of the light absorption anisotropic film with respect to polarized light of the maximal absorption wavelength

Ay0: absorbance of the specific dichroic substance in a transmission axis direction of the light absorption anisotropic film with respect to polarized light of the maximal absorption wavelength

In addition, in a case where the specific dichroic substance is homeotropically aligned in the light absorption anisotropic film (in other words, in a case of having an absorption axis in the thickness direction), the above-described alignment degree is calculated by the following method.

Using AxoScan OPMF-1 (manufactured by Opto Science, Inc.), the transmittance of the light absorption anisotropic film for P-polarized light at the maximal absorption wavelength of the specific dichroic substance is measured. In a case of the measurement, while changing a polar angle, which is an angle of the light absorption anisotropic film with respect to a normal direction, from 0° to 600 in 5° increments, the transmittance at the maximal absorption wavelength of the specific dichroic substance is measured at all azimuthal angles at each polar angle. Next, after removing influence of surface reflection, a transmittance at the azimuthal angle and the polar angle where the transmittance is the highest is defined as Tm (0), and a transmittance at an angle obtained by tilting the polar angle by 400 from the polar angle of the highest transmittance in the azimuthal direction with the highest transmittance is defined as Tm (40). The absorbance is calculated by the following expression based on the obtained Tm (0) and Tm (40), and A (0) and A (40) are calculated.

A=−log(Tm)

Here, Tm represents a transmittance and A represents an absorbance.

An alignment degree S defined by the following expression is calculated based on the calculated A (0) and A (40).

S=(4.6×A(40)−A(0))/(4.6×A(40)+2×A(0))

A film thickness of the light absorption anisotropic film is 10 μm or less, and from the viewpoint that bendability is more excellent, it is preferably 8 μm or less and more preferably 5 m or less. The lower limit thereof is not particularly limited, but from the viewpoint of handleability, it is preferably 0.1 μm or more and more preferably 0.5 μm or more.

The film thickness of the light absorption anisotropic film is an average value obtained by measuring any 10 films of the light absorption anisotropic film using ultra-high resolution non-contact 3D surface profile measurement system BW-A501 manufactured by Nikon Corporation, and arithmetically averaging the obtained values.

<Manufacturing Method of Light Absorption Anisotropic Film>

A manufacturing method of the light absorption anisotropic film is not particularly limited as long as the light absorption anisotropic film having the above-described characteristics can be manufactured.

Among these, from the viewpoint that productivity is more excellent, a manufacturing method of a light absorption anisotropic film, including the following steps 1 and 2, is preferable.

Step 1: step of subjecting a composition containing a dichroic substance having a hydrophilic group and a solvent to a pulverization treatment

Step 2: step of applying the composition obtained in the step 1 and aligning the dichroic substance in the applied composition to form a light absorption anisotropic film

Hereinafter, the procedures of steps 1 and 2 will be described in detail.

(Step 1)

The step 1 is a step of subjecting a composition containing a dichroic substance having a hydrophilic group (the specific dichroic substance) and a solvent (hereinafter, also simply referred to as “specific composition”) to a pulverization treatment. By performing this step, dispersibility of the specific dichroic substance in the specific composition is improved, and as a result, a light absorption anisotropic film in which the aligning properties of the specific dichroic substance are more excellent is obtained. In particular, in a case where the specific composition contains particles composed of the specific dichroic substance, an average particle diameter of the particles is smaller, and a light absorption anisotropic film in which the aligning properties of the specific dichroic substance are more excellent is obtained.

Hereinafter, first, the specific composition to be used will be described in detail, and then the procedure of the step will be described in detail.

The specific composition contains the specific dichroic substance. The specific dichroic substance is as described above.

In the specific composition, the specific dichroic substance is often dispersed in a form of particles. That is, in many cases, the specific composition contains particles composed of the specific dichroic substance.

The specific composition may contain only one kind of the specific dichroic substance, or may contain two or more kinds of the specific dichroic substances.

A content of the specific dichroic substance in the specific composition is not particularly limited, but is preferably 1% to 30% by mass and more preferably 3% to 15% by mass with respect to the total mass of components in the composition excluding a solvent (corresponding to the total solid content in the composition).

The specific composition contains a solvent.

The type of the solvent is not particularly limited, but an aqueous medium is preferable.

The aqueous medium is water or a mixed solution of water and a water-soluble organic solvent.

The water-soluble organic solvent is a solvent having a solubility in water of 5% by mass or more at 20° C. Examples of the water-soluble organic solvent include alcohol compounds, ketone compounds, ether compounds, amide compounds, nitrile compounds, and sulfone compounds.

Examples of the alcohol compound include ethanol, isopropanol, n-butanol, t-butanol, isobutanol, 1-methoxy-2-propanol, diacetone alcohol, diethylene glycol, ethylene glycol, dipropylene glycol, propylene glycol, and glycerin.

Examples of the ketone compound include acetone, methyl ethyl ketone, diethyl ketone, and methyl isobutyl ketone.

Examples of the ether compound include dibutyl ether, tetrahydrofuran, dioxane, dipropylene glycol monomethyl ether, tripropylene glycol monomethyl ether, and polyoxypropylene glyceryl ether.

Examples of the amide compound include dimethylformamide and diethylformamide.

Examples of the nitrile compound include acetonitrile.

Examples of the sulfone compound include dimethyl sulfoxide, dimethyl sulfone, and sulfolane.

A concentration of solid contents of the specific composition is not particularly limited, but from the viewpoint that the aligning properties of the dichroic substance are more excellent, it is preferably 1% to 50% by mass and more preferably 3% to 30% by mass with respect to the total mass of the composition.

The specific composition may contain a component other than the specific dichroic substance and the solvent described above.

Examples of other components include a non-colorable lyotropic liquid crystal compound, a salt, a polymerizable compound, a polymerization initiator, a wavelength dispersion control agent, an optical properties modifier, a surfactant, an adhesion improver, a slipping agent, an alignment control agent, and an ultraviolet absorber.

As described above, the specific composition may contain a non-colorable lyotropic liquid crystal compound. The description of the non-colorable lyotropic liquid crystal compound is as described above.

In a case where the specific composition contains the non-colorable lyotropic liquid crystal compound, a content of the non-colorable lyotropic liquid crystal compound in the specific composition is not particularly limited, but is preferably 60% to 99% by mass and more preferably 80% to 97% by mass with respect to the total solid content in the composition. The total solid content means components which can form the light absorption anisotropic film, excluding the solvent. In a case where the property of the above-described component is in a liquid state, it is counted as the solid content.

In a case where the specific composition contains both the rod-like compound and the plate-like compound, a content of the rod-like compound with respect to the total mass of the rod-like compound and the plate-like compound is not particularly limited, but from the viewpoint that the alignment of the specific dichroic substance in the light absorption anisotropic film is more excellent, it is preferably more than 50% by mass and more preferably 55% by mass or more. The upper limit thereof is not particularly limited, but is preferably 90% by mass or less and more preferably 80% by mass or less.

The specific composition may contain one kind of the rod-like compound, or may contain two or more kinds of the rod-like compounds.

The specific composition may contain one kind of the plate-like compound, or may contain two or more kinds of the plate-like compounds.

As described above, the specific composition may contain a salt. The description of the salt is as described above.

In a case where the specific composition contains the rod-like compound, the plate-like compound, and the salt, a content of the salt is not particularly limited, but a ratio W determined by Expression (W) is preferably 0.25 to 1.75, more preferably 0.50 to 1.50, and still more preferably 0.75 to 1.15.

$$Ratio W = \frac{( C 1 + C 2 + C 3 ) - ( A 1 + A 2 )}{A 2} \qquad ( W )$$

In Expression (W), C1 represents a molar amount of a cation included in the salt of an acid group, which is contained in the rod-like compound. In a case where the rod-like compound does not have the salt of an acid group, C1 is 0.

C2 represents a molar amount of a cation included in the salt of an acid group, which is contained in the plate-like compound. In a case where the plate-like compound does not have the salt of an acid group, C2 is 0.

C3 represents a molar amount of a cation included in the salt.

A1 represents a total molar amount of the acid group or the salt thereof, contained in the rod-like compound. In a case where the rod-like compound contains both the acid group and the salt of an acid group, the above-described total molar amount represents a total molar amount of the acid group and the salt of an acid group. In a case where the rod-like compound has only one of the acid group or the salt of an acid group, the molar amount of one not contained is 0.

A2 represents a total molar amount of the acid group or the salt thereof, contained in the plate-like compound. In a case where the plate-like compound contains both the acid group and the salt of an acid group, the above-described total molar amount represents a total molar amount of the acid group and the salt of an acid group. In a case where the plate-like compound has only one of the acid group or the salt of an acid group, the molar amount of one not contained is 0.

For example, with regard to a composition containing a rod-like compound having a SO₃Li group, a plate-like compound having a SO₃Li group, and LiOH, in a case where a molar amount of the SO₃Li group included in the rod-like compound is 5 mmol, a molar amount of the SO₃Li group included in the plate-like compound is 8 mmol, and a molar amount of LiOH is 8 mmol, it is calculated that a molar amount of the cation included in the salt of an acid group, contained in the rod-like compound, is 5 mmol, a molar amount of the cation included in the salt of an acid group, contained in the plate-like compound, is 8 mmol, and a molar amount of the cation included in LiOH is 8 mmol, and the ratio W is calculated as {(5+8+8)−(5+8)}/8=1.

In a case where the above-described rod-like compound is a rod-like compound having a SO₃H group and the molar amount of the SO₃H group included in the rod-like compound is 5 mmol, the ratio W is calculated as {(8+8)−(5+8)}/8=0.375.

The above-described ratio W represents an amount of cation derived from an excess salt in the composition with respect to the acid group or the salt thereof in the plate-like compound. That is, the ratio W represents a ratio of the amount of excess cations which does not form a salt with the acid group contained in the rod-like compound and plate-like compound in the composition to the acid group or the salt thereof contained in the plate-like compound. In a case where the specific composition contains a predetermined amount of cations with respect to the acid group or the salt thereof contained in the plate-like compound, it is easily assumed that the plate-like compound has a predetermined structure in the light absorption anisotropic film, and the alignment degree of the dichroic substance is more excellent.

In a case where the specific composition contains the salt, a mass ratio of the content of the salt to the content of the plate-like compound in the specific composition is not particularly limited, but is preferably 0.010 to 0.200 and more preferably 0.025 to 0.150.

The specific composition is preferably a lyotropic liquid crystalline composition.

Here, the lyotropic liquid crystalline composition is a composition having a property of causing a phase transition between an isotropic phase and a liquid crystal phase by changing a temperature or a concentration in a solution state. That is, the specific composition is a composition capable of exhibiting lyotropic liquid crystallinity by adjusting the concentration of each compound, or the like in a solution state containing various components such as the specific dichroic substance and the solvent. Even in a case where the specific composition contains an excess solvent and does not exhibit lyotropic liquid crystallinity in that state, the specific composition corresponds to the above-described lyotropic liquid crystalline composition in a case where the lyotropic liquid crystallinity is exhibited upon changes in the concentration, such as a case where the lyotropic liquid crystallinity is exhibited in a drying step after application of the specific composition.

As will be described later, in a case where an alignment film is disposed on a support, the lyotropic liquid crystallinity is exhibited in the drying process after the application of the specific composition, thereby inducing the alignment of the compound and making it possible to form a light absorption anisotropic film.

(Procedure of step 1)

In the step 1, the specific composition is subjected to a pulverization treatment.

As the pulverization treatment, a known pulverization treatment can be used. Examples of a method of the pulverization treatment include a method of applying mechanical energy, such as compression, squeezing, impact, shearing, rubbing, and cavitation.

The pulverization treatment may be a wet pulverization treatment or a dry pulverization treatment. Specific examples of the pulverization treatment include treatments using a beads mill, a sand mill, a roll mill, a ball mill, a paint shaker, a microfluidizer, an impeller mill, a sand grinder, a flow jet mixer, an ultrasonic treatment, or the like.

As the pulverization treatment, from the viewpoint that aligning properties of the specific dichroic substance in the light absorption anisotropic film are more excellent, a mechanical milling treatment or an ultrasonic treatment is preferable, and a mechanical milling treatment is more preferable.

The mechanical milling treatment is not particularly limited as long as it is a method of milling while applying mechanical energy, and examples thereof include treatments using a ball mill, a vibration mill, a turbo mill, a mechanofusion, and a disc mill.

In a case where the specific composition contains particles composed of the specific dichroic substance, by performing the pulverization treatment, the particles are pulverized to obtain smaller particles (miniaturized particles).

Conditions of the pulverization treatment are not particularly limited, and optimal conditions are appropriately selected depending on the types of the specific dichroic substance and the solvent used.

For example, in a case where the mechanical milling treatment (particularly, a ball mill treatment) is adopted as the pulverization treatment, a material of pulverizing balls (media) used in the ball milling is not particularly limited, and examples thereof include agate, silicon nitride, zirconia, alumina, and an iron-based alloy. From the viewpoint that aligning properties of the specific dichroic substance in the light absorption anisotropic film are more excellent, zirconia is preferable.

An average particle diameter of the pulverizing balls is not particularly limited, but from viewpoint that aligning properties of the specific dichroic substance in the light absorption anisotropic film are more excellent, it is preferably 0.1 to 10 mm and more preferably 1 to 5 mm. The above-described average particle diameter is a value obtained by measuring diameters of any 50 pulverizing balls and arithmetically averaging the diameters. In a case where the pulverizing ball is not spherical, a major axis is taken as the diameter.

A rotation speed during the ball milling is not particularly limited, but from viewpoint that aligning properties of the specific dichroic substance in the light absorption anisotropic film are more excellent, it is preferably 100 to 700 rpm and more preferably 250 to 550 rpm.

A treatment time of the ball milling is not particularly limited, but from viewpoint that aligning properties of the specific dichroic substance in the light absorption anisotropic film are more excellent, it is preferably 10 to 240 minutes and more preferably 20 to 180 minutes.

The atmosphere during the ball milling may be an atmosphere of atmospheric air, or may be an atmosphere of an inert gas (for example, argon, helium, or nitrogen).

It is preferable that, by the pulverization treatment, the average particle diameter of the particles composed of the specific dichroic substance, contained in the specific composition, is miniaturized to be 1/30 to ½ times.

That is, the particles composed of the specific dichroic substance may be contained in the specific composition after the pulverization treatment, and the average particle diameter of the particles is not particularly limited, but from the viewpoint that the alignment degree of the dichroic substance is more excellent, it is preferably 10 to 1000 nm, more preferably 10 to 500 nm, and still more preferably 10 to 200 nm.

The average particle diameter of the particles is a volume average particle size (MV) obtained by a dynamic light scattering method using Nanotrack UPA-EX manufactured by MicrotracBEL Corp.

As described above, the specific composition subjected to the pulverization treatment may or may not contain a component other than the specific dichroic substance and the solvent, such as a non-colorable lyotropic liquid crystal compound.

In a case where the specific composition subjected to the pulverization treatment does not contain the other components (for example, a non-colorable lyotropic liquid crystal compound), the specific composition obtained after the pulverization treatment may be further mixed with the other components (for example, the non-colorable lyotropic liquid crystal compound), and then the step 2 described below may be performed.

(Step 2)

The step 2 is a step of applying the composition (specific composition) obtained in the step 1 and aligning the dichroic substance (specific dichroic substance) in the applied composition to form a light absorption anisotropic film. By performing this step, the light absorption anisotropic film according to the embodiment of the present invention, having light absorption anisotropy, is manufactured.

A method of applying the specific composition obtained in the step 1 is not particularly limited, and usually, the specific composition is applied onto a support.

The support to be used is a member having a function as a base material to which the composition is applied. The support may be a so-called temporary support.

Examples of the support (temporary support) include a plastic substrate and a glass substrate. Examples of a material constituting the plastic substrate include a polyester resin such as polyethylene terephthalate, a polycarbonate resin, a (meth)acrylic resin, an epoxy resin, a polyurethane resin, a polyamide resin, a polyolefin resin, a cellulose resin, a silicone resin, and a polyvinyl alcohol.

A thickness of the support may be approximately 5 to 1000 m, and is preferably 10 to 250 μm and more preferably 15 to 90 μm.

As necessary, an alignment film may be disposed on the support.

The alignment film generally contains a polymer as a main component. The polymer for the alignment film is described in a large number of documents, and a large number of commercially available polymer products are available. The polymer for the alignment film is preferably a polyvinyl alcohol, a polyimide, a derivative thereof, an azo derivative, or a cinnamoyl derivative.

It is preferable that the alignment film is subjected to a known rubbing treatment.

In addition, a photo-alignment film may be used as the alignment film.

A thickness of the alignment film is preferably 0.01 to 10 μm and more preferably 0.01 to 1 μm.

The application method may be, for example, a known method, examples thereof include a curtain coating method, an extrusion coating method, a roll coating method, a dip coating method, a spin coating method, a print coating method, a spray coating method, and a slide coating method.

In addition, in a case where the specific composition is a lyotropic liquid crystalline composition, by adopting a coating method of applying a shearing force to the composition, such as wire bar coating, it is possible to simultaneously perform two treatments of application and alignment of the compound. That is, the specific dichroic substance can be aligned by subjecting the composition to a shearing treatment.

In addition, in a case where the specific composition contains the non-colorable lyotropic liquid crystal compound, by continuous application, the non-colorable lyotropic liquid crystal compound may be continuously aligned at the same time as the coating. Examples of the continuous application include a curtain coating method, an extrusion coating method, a roll coating method, and a slide coating method.

A method of aligning the specific dichroic substance in the applied composition is not particularly limited, and a known method is adopted.

For example, in a case where the specific composition contains the non-colorable lyotropic liquid crystal compound, examples thereof include a method of applying a shearing force as described above.

Examples of another method of aligning the specific dichroic substance in the applied composition include a method of using an alignment film as described above.

An alignment direction can be controlled by subjecting the alignment film to an alignment treatment in advance in a predetermined direction. In particular, the method of using an alignment film is preferable in a case where continuous application is carried out using a roll-like support so that the compound is aligned in a direction oblique to a transport direction.

In the method of using an alignment film, a concentration of the solvent in the specific composition used is not particularly limited, and may be a concentration such that the composition exhibits lyotropic liquid crystallinity, or may be a concentration equal to or lower than the concentration. As described above, in a case where the specific composition is a lyotropic liquid crystalline composition, even in a case where the concentration of the solvent in the specific composition is high (a case where the specific composition itself exhibits an isotropic phase), in the drying process after the application of the specific composition, lyotropic liquid crystallinity is exhibited, which induces alignment of the dichroic substance on the alignment film and makes it possible to form the light absorption anisotropic film.

(Other Steps)

The manufacturing method of the light absorption anisotropic film according to the embodiment of the present invention may include a step other than the step 1 and the step 2 described above.

As other steps, in a case where the specific composition contains the non-colorable lyotropic liquid crystal compound, it is preferable to further include a step 3 of immobilizing the non-colorable lyotropic liquid crystal compound after the step 2.

A method of fixing an alignment state of the non-colorable lyotropic liquid crystal compound is not particularly limited, and examples thereof include a method of heating and then cooling a coating film as described above.

In addition, in a case where at least one of the rod-like compound, the plate-like compound, or the specific dichroic substance has an acid group or a salt thereof, examples of a method of fixing an alignment state of the lyotropic liquid crystal compound include a method of bringing a solution containing a polyvalent metal ion into contact with the formed light absorption anisotropic film. By bringing the solution containing a polyvalent metal ion into contact with the formed light absorption anisotropic film, the polyvalent metal ion is supplied into the light absorption anisotropic film. The polyvalent metal ion supplied into the light absorption anisotropic film serves as a crosslinking point between the acid groups or the salts thereof contained in the rod-like compound, the plate-like compound, and/or the specific dichroic substance, a crosslinking structure is formed in the light absorption anisotropic film, and the alignment state of the lyotropic liquid crystal compound is fixed.

The type of the polyvalent metal ion used is not particularly limited, but from the viewpoint that the alignment state of the non-colorable lyotropic liquid crystal compound and/or the specific dichroic substance is easily fixed, an alkaline earth metal ion is preferable, and a calcium ion is more preferable.

<Application>

The light absorption anisotropic film according to the embodiment of the present invention can be applied to various applications.

For example, the light absorption anisotropic film according to the embodiment of the present invention can be used as a polarizer. In particular, the light absorption anisotropic film according to the embodiment of the present invention can be used as a polarizer for near-infrared rays, which can absorb light having a wavelength of 700 to 1600 nm.

In addition, the light absorption anisotropic film according to the embodiment of the present invention may be used in combination with other members.

For example, a protective film may be disposed on one side or both sides of the light absorption anisotropic film according to the embodiment of the present invention. In a case where the protective film is disposed, it may be disposed through an adhesive or a pressure sensitive adhesive.

Examples of the protective film include a triacetyl cellulose film, an acrylic film, a polycarbonate film, and a cycloolefin film. As the protective film, a film which is transparent, has a small amount of birefringence, and hardly causes a phase difference is preferable.

In addition, the light absorption anisotropic film according to the embodiment of the present invention may be combined with other layers such as a hardcoat layer, an antiglare layer, and an antireflection layer. These other layers may be disposed through an adhesive or a pressure sensitive adhesive.

The light absorption anisotropic film according to the embodiment of the present invention can also be used by being bonded to an inorganic substrate such as a prism and glass, or a plastic plate. In a case where the inorganic substrate and the plastic substrate have a curved surface, a curved surface can also be formed by bonding the light absorption anisotropic film according to the embodiment of the present invention to the curved surface.

The light absorption anisotropic film according to the embodiment of the present invention may be combined with various functional layers for improving a viewing angle, various functional layers for improving contrast, a layer having brightness improving properties, and the like.

Examples of the above-described various functional layers include a layer which controls a phase difference.

The light absorption anisotropic film according to the embodiment of the present invention, combined with such various functional layers, can be applied to various display devices such as a liquid crystal display device.

In addition to the above, the light absorption anisotropic film according to the embodiment of the present invention can be applied to liquid crystal projectors, calculators, clocks, laptops, word processors, liquid crystal televisions, polarized lenses, polarized glasses, car navigation systems, sensors, lenses, switching elements, isolators, cameras, indoor and outdoor measuring instruments, and displays for cars.

Among these, the light absorption anisotropic film according to the embodiment of the present invention is suitably applied to a display device, a camera (particularly, a polarized multispectral camera), and a sensor. That is, the present invention also relates to a display device including the light absorption anisotropic film according to the embodiment of the present invention, a camera including the light absorption anisotropic film according to the embodiment of the present invention, and a sensor including the light absorption anisotropic film according to the embodiment of the present invention.

In addition, the light absorption anisotropic film according to the embodiment of the present invention may be combined with an infrared light source. That is, the present invention also relates to an apparatus including the light absorption anisotropic film according to the embodiment of the present invention and an infrared light source. Examples of such an apparatus include a distance measurement device such as Light Detection and Ranging (LIDAR) Examples

Hereinafter, features of the present invention will be described in more detail with reference to Examples and Comparative Examples. The materials, amounts used, proportions, treatment details, treatment procedure, and the like shown in the following Examples can be appropriately changed without departing from the spirit and scope of the present invention. Accordingly, the scope of the present invention should not be construed as being limited by the specific examples given below.

### Synthesis

The following plate-like compound I-1, rod-like compounds II-1 and II-2, and dichroic substances III-1 to III-6 were synthesized by a known method.

Each of the rod-like compounds II-1 and II-2 was a polymer (n was 2 or more), the number-average molecular weight of the rod-like compound II-1 was 24,000 and the molecular weight distribution was 6.8, and the number-average molecular weight of the rod-like compound II-2 was 25,000 and the molecular weight distribution was 5.1.

In addition, the plate-like compound I-1 and the rod-like compounds II-1 and II-2 all exhibited lyotropic liquid crystallinity.

In addition, the plate-like compound I-1 and the rod-like compounds II-1 and II-2 all satisfied the above-described non-colorable requirement. More specifically, the absorbance in a visible light range (wavelength of 400 to 700 nm) was 0.1 or less in a case of measuring the ultraviolet-visible absorption spectrum of the solution in which the above-described compound was dissolved at a concentration such that the absorbance at the maximum absorption wavelength in an ultraviolet light range (wavelength of 230 to 400 nm) was 1.0.

Plate-like compound I-1 (see the following structural formula)

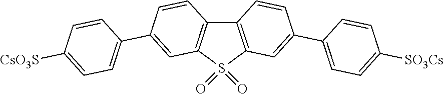

Rod-like compound II-1 (see the following structural formula)

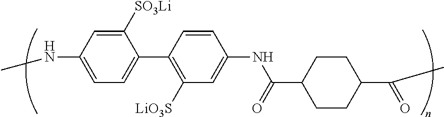

Rod-like compound II-2 (see the following structural formula)

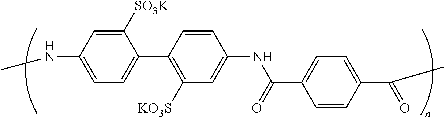

Dichroic substance III-1 (see the following structural formula)

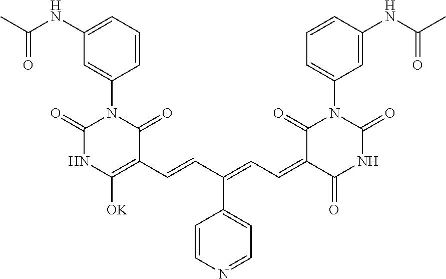

Dichroic substance III-2 (see the following structural formula)

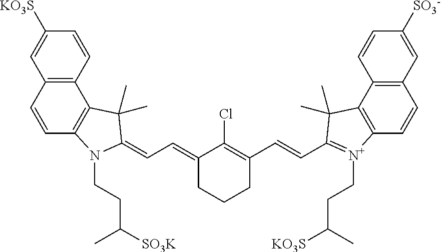

Dichroic substance III-3 (see the following structural formula)

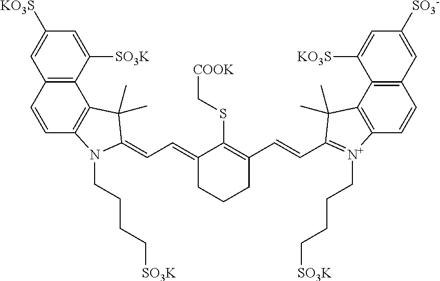

Dichroic substance III-4 (see the following structural formula)

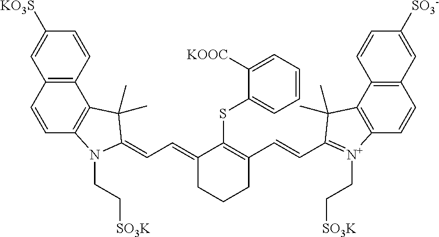

Dichroic substance III-5 (see the following structural formula)

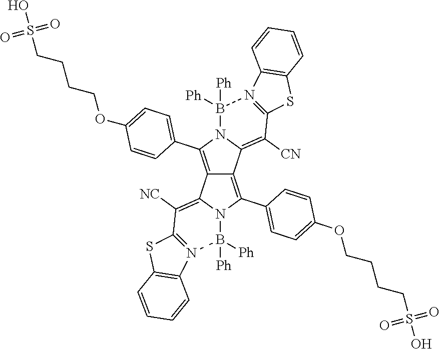

Dichroic substance III-6 (see the following structural formula)

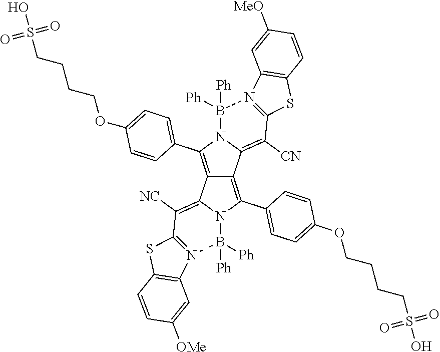

The plate-like compound I-1 had a maximal absorption wavelength at 345 nm.

The rod-like compound II-1 had a maximal absorption wavelength at 260 nm.

The rod-like compound II-2 had a maximal absorption wavelength at 290 nm.

The dichroic coloring agent III-1 had a maximal absorption wavelength at 625 nm in dimethyl sulfoxide.

The dichroic coloring agent III-2 had a maximal absorption wavelength at 840 nm in water.

The dichroic coloring agent III-3 had a maximal absorption wavelength at 816 nm in water.

The dichroic coloring agent III-4 had a maximal absorption wavelength at 824 nm in water.

The dichroic coloring agent III-5 had a maximal absorption wavelength at 768 nm in methanol.

The dichroic coloring agent III-6 had a maximal absorption wavelength at 783 nm in methanol.

### Example 1

A composition 1 having the following composition was prepared. The composition 1 was a composition exhibiting lyotropic liquid crystallinity.

### Composition 1

| | | |
|---|---|---|
| Dichroic coloring agent III-2 | 5 | parts by mass |
| Water | 95 | parts by mass |

The composition 1 (5 g) prepared above and zirconia beads (20 g) having an average particle diameter of 2 mm were filled in a zirconia 45 mL container, and using a planetary ball mill P-7 classic line manufactured by Fritsch GmbH, milling was performed for 50 minutes at a rotation speed of 300 rpm.

The composition 1 which had been subjected to the milling treatment described above was applied onto a glass substrate as a base material with a wire bar (moving speed: 100 cm/s), and naturally dried.

Next, the obtained composition layer was immersed in a 1 mol/L calcium chloride aqueous solution for 5 seconds, washed with ion exchange water, and blast-dried to fix the alignment state, thereby producing a light absorption anisotropic film 1 having a film thickness of 200 nm.

The film thickness was measured by the above-described method using ultra-high resolution non-contact 3D surface profile measurement system BW-A501 manufactured by Nikon Corporation.

### Example 2

A composition 2 having the following composition was prepared. The composition 2 was a composition exhibiting lyotropic liquid crystallinity.

### Composition 2

| | | |
|---|---|---|
| Plate-like compound I-1 | 10 | parts by mass |
| Dichroic coloring agent III-2 | 0.5 | parts by mass |
| Water | 89.5 | parts by mass |

The composition 2 (5 g) prepared above and zirconia beads (20 g) having an average particle diameter of 2 mm were filled in a zirconia 45 mL container, and using a planetary ball mill P-7 classic line manufactured by Fritsch GmbH, milling was performed for 50 minutes at a rotation speed of 300 rpm.

The composition 2 which had been subjected to the milling treatment described above was applied onto a glass substrate as a base material with a wire bar (moving speed: 100 cm/s), and naturally dried.

Next, the obtained composition layer was immersed in a 1 mol/L calcium chloride aqueous solution for 5 seconds, washed with ion exchange water, and blast-dried to fix the alignment state, thereby producing a light absorption anisotropic film 2 having a film thickness of 1.2 μm.

### Examples 3 to 9

Light absorption anisotropic films 3 to 9 having a film thickness of 1.2 μm were produced by the same method as in Example 2, except that the plate-like compound or the dichroic coloring agent was changed to the compound described in Table 1. All of the compositions 3 to 9 prepared in Examples 3 to 9 were compositions exhibiting lyotropic liquid crystallinity.

### Example 10

A composition 10 having the following composition was prepared. The composition 10 was a composition exhibiting lyotropic liquid crystallinity.

### Composition 10

| | | |
|---|---|---|
| Rod-like compound II-1 | 10 | parts by mass |
| Dichroic coloring agent III-1 | 0.5 | parts by mass |
| Dichroic coloring agent III-2 | 0.5 | parts by mass |
| Water | 89 | parts by mass |

The composition 10 (5 g) prepared above and zirconia beads (20 g) having an average particle diameter of 2 mm were filled in a zirconia 45 mL container, and using a planetary ball mill P-7 classic line manufactured by Fritsch GmbH, milling was performed for 50 minutes at a rotation speed of 300 rpm.

The composition 10 which had been subjected to the milling treatment described above was applied onto a glass substrate as a base material with a wire bar (moving speed: 100 cm/s), and naturally dried.

Next, the obtained composition layer was immersed in a 1 mol/L calcium chloride aqueous solution for 5 seconds, washed with ion exchange water, and blast-dried to fix the alignment state, thereby producing a light absorption anisotropic film 10 having a film thickness of 1.2 μm.

The particle diameter was measured using Nanotrack UPA-EX manufactured by MicrotracBEL Corp, and
in Examples 1 to 10, the average particle diameters of the particles of the dichroic coloring agent in the composition after the ball milling dispersion treatment were all 10 to 200 nm.

The average particle diameter of the particles of the dichroic substance was miniaturized to approximately 0.1 times by the ball milling dispersion treatment.

### Examples 11 to 13

Light absorption anisotropic films 11 to 13 having a film thickness of 1.2 μm were produced according to the same procedure as in Examples 4 to 6, except that the ball milling dispersion treatment was not performed.

The average particle diameters of the particles of the dichroic coloring agent in the compositions used for forming the light absorption anisotropic films 11 to 13 were all more than 500 nm.

### Example 14

A light absorption anisotropic film 14 having a film thickness of 1.2 μm was produced according to the same procedure as in Example 4, except that the fixing treatment using calcium chloride was not performed.

### Comparative Example 1

A composition C1 having the following composition was prepared.

### Composition C1

| | | |
|---|---|---|
| Cyanine coloring agent C1 | 0.15 | parts by mass |
| VYLON UR8200 (manufactured by | 100 | parts by mass |
| TOYOBO CO., LTD.) | | |

C1 (cyanine coloring agent described in Example 5 of WO2018/088558A, see the following structural formula)

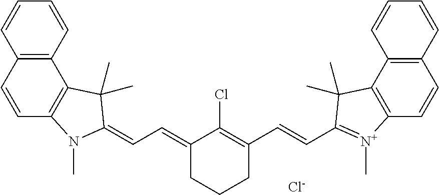 [SMILES: CN1/C(=C/C=C2\CCCC(/C=C/C3=[N+](C)c4ccc5ccccc5c4C3(C)C)=C2Cl)C(C)(C)c2c1ccc1ccccc21 ; [Cl-]]

The composition C1 was applied onto a glass substrate as a base material at a film thickness of 250 m, and then dried to obtain an organic film having a film thickness of 75 μm. Next, the obtained organic film was stretched 3 times at 80° C. to produce a light absorption anisotropic film C1 having a film thickness of 25 μm.

<Evaluation>

(Optical Properties)

The alignment degree, polarization degree, and transmittance were measured for the obtained light absorption anisotropic films 1 to 14 and C1.

In the light absorption anisotropic films 1 to 14, the maximal absorption wavelength was observed on the longer wavelength side than the maximal absorption wavelength of the dichroic substance used, and it was confirmed that all the light absorption anisotropic films contained a J-aggregate composed of the dichroic substance. The results of the maximal absorption wavelengths of the light absorption anisotropic films in a wavelength range of 700 to 1600 nm are summarized in Table 1 described later.

The light absorption anisotropic films 1 to 14 each had an absorption axis at the maximal absorption wavelength of each film in the in-plane direction.

With regard to the alignment degree, polarization degree, and transmittance, using an ultraviolet-visible-near infrared spectrophotometer V-660 including an automatic absolute reflectivity measuring unit ARMN-735, manufactured by Jasco Corporation, the absorbance and transmittance of the light absorption anisotropic film was measured to calculate the alignment degree, the polarization degree, and the transmittance from the following expression. The results are summarized in Table 1.

As the polarized light used in the following measurement, polarized light having a maximal absorption wavelength in a wavelength range of 700 to 1600 nm of each film was used. The maximal absorption wavelength also corresponds to the maximal absorption wavelength of the J-aggregate composed of the dichroic substance in each light absorption anisotropic film.

Alignment degree=[(Az0/Ay0)−1]/[(Az0/Ay0)+2]
Az0: absorbance of a light absorption anisotropic film with respect to polarized light in an absorption axis direction
Ay0: absorbance of a light absorption anisotropic film with respect to polarized light in a transmission axis direction

Polarization degree=[Ty0−Tz0]/[Ty0+Tz0]
Tz0: transmittance of a light absorption anisotropic film with respect to polarized light in an absorption axis direction
Ty0: transmittance of a light absorption anisotropic film with respect to polarized light in a transmission axis direction

Transmittance=[Ty0+Tz0]/2
Tz0: transmittance of a light absorption anisotropic film with respect to polarized light in an absorption axis direction
Ty0: transmittance of a light absorption anisotropic film with respect to polarized light in a transmission axis direction

(Bendability)

A cellulose acylate film produced by [Production of cellulose acylate film] described later (hereinafter, also simply referred to as “TAC film”) was used as the base material instead of the glass substrate, and a laminate L1 was including the TAC film and the light absorption anisotropic film was manufactured according to the same procedure as in Example 1.

Next, a surface of the laminate L1 on the light absorption anisotropic film side was bonded to a separately prepared TAC film using a commercially available pressure sensitive adhesive (SK-2057 manufactured by Soken Chemical & Engineering Co., Ltd.), and the TAC film in contact with a surface of the light absorption anisotropic film opposite to the pressure sensitive adhesive side was peeled off, thereby producing a measurement sample 1 (width: 15 mm, length: 150 mm) including the light absorption anisotropic film 1, the pressure sensitive adhesive layer, and the TAC film in this order.

For Examples 2 to 14, measurement samples 2 to 14 in which the light absorption anisotropic films 2 to 14 each were disposed instead of the light absorption anisotropic film 1 were produced according to the same procedure as described above.

In addition, the light absorption anisotropic film C1 was bonded to a TAC film using a commercially available pressure sensitive adhesive (SK-2057 manufactured by Soken Chemical & Engineering Co., Ltd.) to obtain a measurement sample C1 including the light absorption anisotropic film C1, the pressure sensitive adhesive layer, and the TAC film in this order.

Next, the measurement sample was allowed to stand for 1 hour or more in a state in which the temperature was 25° C. and the relative humidity was 60%. Thereafter, using a 180° folding endurance tester (manufactured by IMOTO MACHINERY CO., LTD., IMC-0755), a repeated bending resistance test was performed with the TAC film on the outside. In the tester used, an operation in which the measurement sample was bent along the curved surface of a rod (cylinder) having a diameter of 2 mm at a central portion in a longitudinal direction at a bending angle of 180°, and then was returned to the original (spreading the sample film) was regarded as one test, and this test was repeated. In repeating the above-described 1800 bending test at 200 times/min, a case where the maximum number of times that cracks did not occur in the light absorption anisotropic film exceeded 400,000 times was indicated by A, a case of being more than 100,000 times and 400,000 times or less was indicated by B, and a case of being more than 1 time and 100,000 times or less was indicated by C. The presence or absence of cracks was evaluated with an optical microscope.

The results are shown in Table 1. Practically, A or B is preferable, and A is more preferable.

(Production of Cellulose Acylate Film)

The cellulose acylate film was produced in the following manner.

The following composition was put into a mixing tank and stirred, thereby preparing a cellulose acetate solution used as a core layer cellulose acylate dope.

### Core Layer Cellulose Acylate Dope

| | | |
|---|---|---|
| Cellulose acetate having acetyl substitution | 100 | parts by mass |
| degree of 2.88 | | |
| Polyester compound B described in Examples | 12 | parts by mass |
| of JP2015-227955A | | |
| Compound F shown below | 2 | parts by mass |
| Methylene chloride (first solvent) | 430 | parts by mass |
| Methanol (second solvent) | 64 | parts by mass |

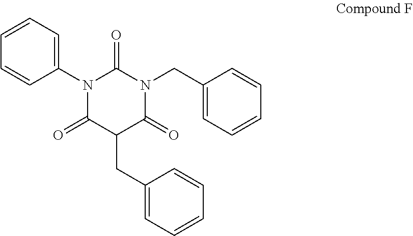 [SMILES: O=C1C(Cc2ccccc2)C(=O)N(c2ccccc2)C(=O)N1Cc1ccccc1]

10 parts by mass of the following matting agent solution was added to 90 parts by mass of the above-described core layer cellulose acylate dope, thereby preparing a cellulose acetate solution used as an outer layer cellulose acylate dope.

### Matting Agent Solution

| | | |
|---|---|---|
| Silica particles having average particle | 2 | parts by mass |
| diameter of 20 nm | | |
| (AEROSIL R972, manufactured by Nippon | | |
| Aerosil Co., Ltd.) | | |
| Methylene chloride (first solvent) | 76 | parts by mass |
| Methanol (second solvent) | 11 | parts by mass |
| Core layer cellulose acylate dope described | 1 | parts by mass |
| above | | |

The core layer cellulose acylate dope and the outer layer cellulose acylate dope were filtered through filter paper having an average hole diameter of 34 μm and a sintered metal filter having an average pore size of 10 m, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state in which the solvent content in the film was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to prepare an optical film having a thickness of 40 m, and the optical film was used as a cellulose acylate film. The in-plane retardation of the obtained cellulose acylate film was 0 nm.

(Moisture-Heat Resistance)

With regard to test conditions for the moisture-heat resistance, a test in which an object was left to stand in an environment of 85° C. and a relative humidity of 85% for 500 hours was carried out.

The polarization degree of the light absorption anisotropic film before the test and the polarization degree of the light absorption anisotropic film after the test were measured, and the moisture-heat resistance was evaluated according to the following standard. The results are shown in Table 1 below.
A: change amount in polarization degree after the test with respect to polarization degree before the test was less than 20%.
B: change amount in polarization degree after the test with respect to polarization degree before the test was 20% or more and less than 60%.
C: change amount in polarization degree after the test with respect to polarization degree before the test was 60% or more.

In Table 1, “Maximal absorption wavelength (nm)” in the column of “Dichroic substance” indicates the maximal absorption wavelength (nm) of the dichroic substance, and “Maximal absorption wavelength (nm)” in the column of “Light absorption anisotropic film” indicates the maximal absorption wavelength (nm) of the light absorption anisotropic film in a wavelength range of 700 to 1600 nm.

In Table 1, the column of “Pulverization treatment” indicates whether or not the pulverization treatment was performed, and “Present” indicates a case where the pulverization treatment was performed and “Absent” indicates a case where the pulverization treatment was not performed.

In Table 1, the column of “Fixing treatment” indicates whether or not the fixing treatment was performed, and “Present” indicates a case where the fixing treatment was performed and “Absent” indicates a case where the fixing treatment was not performed.

In Table 1, the column of “Alignment degree” indicates the alignment degree of the dichroic substance, which was measured by the above-described method.

TABLE 1

| | | Dichroic substance | | | | Light absorption anisotropic film | | | | | | |
|---|---|---|---|---|---|---|---|---|---|---|---|---|
| | Liquid | | Maximal | | | Film | | Maximal | | | Evaluation | |
| | crystal | | absorption | | | thick- | | absorption | | Trans- | | Moisture- |
| | compound | | wavelength | Pulverization | Fixing | ness | Alignment | wavelength | Polarization | mittance | Bend- | heat |
| | Type | Type | (nm) | treatment | treatment | (μm) | degree | (nm) | degree (%) | (%) | ability | resistance |
| Example 1 | None | III-2 | 840 | Present | Present | 0.2 | 0.94 | 942 | 99.99 | 15 | A | A |
| Example 2 | I-1 | III-2 | 840 | Present | Present | 1.2 | 0.90 | 942 | 95 | 40 | A | A |
| Example 3 | II-1 | III-1 | 625 | Present | Present | 1.2 | 0.85 | 830 | 94 | 36 | A | B |
| Example 4 | II-1 | III-2 | 840 | Present | Present | 1.2 | 0.90 | 942 | 95 | 40 | A | A |
| Example 5 | II-1 | III-3 | 816 | Present | Present | 1.2 | 0.92 | 891 | 95 | 42 | A | A |
| Example 6 | II-1 | III-4 | 824 | Present | Present | 1.2 | 0.88 | 957 | 95 | 39 | A | A |
| Example 7 | II-1 | III-5 | 768 | Present | Present | 1.2 | 0.70 | 872 | 90 | 30 | A | A |
| Example 8 | II-1 | III-6 | 783 | Present | Present | 1.2 | 0.70 | 883 | 90 | 30 | A | A |
| Example 9 | II-2 | III-2 | 840 | Present | Present | 1.2 | 0.90 | 942 | 95 | 40 | A | A |
| Example 10 | II-1 | III-1 | 625 | Present | Present | 1.2 | 0.85 | 830 | 95 | 40 | A | B |
| | | III-2 | 840 | | | | 0.90 | 942 | | | | |
| Example 11 | II-1 | III-2 | 840 | Absent | Present | 1.2 | 0.80 | 942 | 94 | 30 | A | A |
| Example 12 | II-1 | III-3 | 816 | Absent | Present | 1.2 | 0.80 | 891 | 94 | 30 | A | A |
| Example 13 | II-1 | III-4 | 824 | Absent | Present | 1.2 | 0.80 | 957 | 94 | 30 | A | A |
| Example 14 | II-1 | III-2 | 840 | Present | Absent | 1.2 | 0.90 | 942 | 95 | 40 | A | C |
| Comparative | None | C1 | 845 | Absent | Absent | 25 | 0.85 | 845 | 94 | 36 | C | C |
| Example 1 | | | | | | | | | | | | |

From the results of Table 1, it was confirmed that the desired effects were exhibited in the light absorption anisotropic films according to the embodiment of the present invention.

From the comparison between Example 14 and other Examples, it was confirmed that the moisture-heat resistance was more excellent in a case where the fixing treatment was performed.

From the comparison of Examples 3 to 8, it was confirmed that the alignment degree was higher in a case of the oxonol-based coloring agent having a hydrophilic group or the cyanine-based coloring agent having a hydrophilic group.

In addition, from the comparison between Examples 3 and 10 and other Examples, it was confirmed that, in a case of the oxonol-based coloring agent having a hydrophilic group, the moisture-heat resistance was slightly deteriorated, and in a case of the cyanine-based coloring agent having a hydrophilic group and the boron complex-based coloring agent having a hydrophilic group, the effect was more excellent.

### EXPLANATION OF REFERENCES

10: rod-like compound
12: specific dichroic substance

What is claimed is:

1. Alight absorption anisotropic film comprising:
a dichroic substance having a hydrophilic group,
wherein a film thickness is 10 μm or less, and
the light absorption anisotropic film has a maximal absorption wavelength in a wavelength range of 700 to 1600 nm.

2. The light absorption anisotropic film according to claim 1,
wherein the light absorption anisotropic film contains a J-aggregate composed of the dichroic substance.

3. The light absorption anisotropic film according to claim 1,
wherein an alignment degree of the dichroic substance is 0.60 or more.

4. The light absorption anisotropic film according to claim 1,
wherein the light absorption anisotropic film contains two or more kinds of the dichroic substances, and
the light absorption anisotropic film has a first maximal absorption wavelength in a wavelength range of 700 nm or more and less than 900 nm and a second maximal absorption wavelength in a wavelength range of 900 to 1600 nm.

5. The light absorption anisotropic film according to claim 1, further comprising:
a non-colorable lyotropic liquid crystal compound.

6. A manufacturing method of a light absorption anisotropic film, comprising:
a step 1 of subjecting a composition containing a dichroic substance having a hydrophilic group and a solvent to a pulverization treatment; and
a step 2 of applying the composition obtained in the step 1 and aligning the dichroic substance in the applied composition to form a light absorption anisotropic film.

7. The manufacturing method of a light absorption anisotropic film according to claim 6,
wherein the composition obtained in the step 1 contains particles composed of the dichroic substance, and
an average particle diameter of the particles is 10 to 1000 nm.

8. The manufacturing method of a light absorption anisotropic film according to claim 6,
wherein the pulverization treatment is a treatment selected from the group consisting of a mechanical milling treatment and an ultrasonic treatment.

9. The manufacturing method of a light absorption anisotropic film according to claim 6,
wherein the composition contains a non-colorable lyotropic liquid crystal compound, and
in the step 2, the composition is subjected to a shearing treatment to align the dichroic substance.

10. The manufacturing method of a light absorption anisotropic film according to claim 9, further comprising, after the step 2:
a step 3 of immobilizing the lyotropic liquid crystal compound.

11. A display device comprising:
the light absorption anisotropic film according to claim 1.

12. A camera comprising:
the light absorption anisotropic film according to claim 1.

13. A sensor comprising:
the light absorption anisotropic film according to claim 1.

14. An apparatus comprising:
the light absorption anisotropic film according to claim 1; and
an infrared light source.

15. The light absorption anisotropic film according to claim 2,
wherein an alignment degree of the dichroic substance is 0.60 or more.

16. The light absorption anisotropic film according to claim 2,
wherein the light absorption anisotropic film contains two or more kinds of the dichroic substances, and
the light absorption anisotropic film has a first maximal absorption wavelength in a wavelength range of 700 nm or more and less than 900 nm and a second maximal absorption wavelength in a wavelength range of 900 to 1600 nm.

17. The light absorption anisotropic film according to claim 2, further comprising:
a non-colorable lyotropic liquid crystal compound.

18. The manufacturing method of a light absorption anisotropic film according to claim 7,
wherein the pulverization treatment is a treatment selected from the group consisting of a mechanical milling treatment and an ultrasonic treatment.

19. The manufacturing method of a light absorption anisotropic film according to claim 7,
wherein the composition contains a non-colorable lyotropic liquid crystal compound, and
in the step 2, the composition is subjected to a shearing treatment to align the dichroic substance.

20. The manufacturing method of a light absorption anisotropic film according to claim 19, further comprising, after the step 2:
a step 3 of immobilizing the lyotropic liquid crystal compound.
